(19) United States
(12) Patent Application Publication
(10) Pub. No.: US 2026/0232029 A1
(43) Pub. Date: Aug. 13, 2026

(54) MESH SUSCEPTOR ASSEMBLY

(71) Applicant: Philip Morris Products S.A., Neuchatel (CH)

(72) Inventors: Farhang MOHSENI, Neuchâtel (CH); Jean-Marc WIDMER, Lignières (CH)

(73) Assignee: Philip Morris Products S.A., Neuchatel (CH)

(21) Appl. No.: 19/156,574

(22) PCT Filed: Feb. 19, 2024
(86) PCT No.: PCT/EP2024/054162

§ 371 Date: Aug. 14, 2025

(30) Foreign Application Priority Data
Feb. 20, 2023 (EP) 23157570

(51) Int. Cl. A24F 40/465; A24F 40/10; A24F 40/42; A24F 40/44; A24F 40/57; H05B 6/10

(52) U.S. Cl. CPC A24F 40/465; A24F 40/10; A24F 40/42; A24F 40/44; A24F 40/57; H05B 6/105

(57) ABSTRACT

A susceptor assembly for an aerosol-generating system is provided, the susceptor assembly including: an array of filaments of a wicking material configured to convey liquid aerosol-forming substrate, the array of filaments forming a mesh; and at least one filament of an electrically conductive material heatable by penetration with an alternating magnetic field, the at least one filament of the electrically conductive material being wrapped around and in contact with a first filament of the array of filaments of the wicking material.

The present disclosure relates to a susceptor assembly for an aerosol-generating system; cartridge for an aerosol-generating system; an aerosol-generating system; and a method for manufacturing a susceptor assembly.

Aerosol-generating systems that employ inductive heating to heat a liquid aerosol-forming substrate in order to generate an aerosol for user inhalation are known in the art. The liquid aerosol-forming substrate is heated and vaporised to form a vapour. The vapour cools and condenses to form an aerosol, and this aerosol is then inhaled by a user. Such aerosol-generating systems are typically handheld and comprise a power supply, a reservoir for holding a supply of the liquid aerosol-forming substrate and an inductive heating system.

Inductive heating systems typically comprise at least one inductor coil connected to the power supply and configured to generate an alternating magnetic field. The inductive heating systems comprise a susceptor assembly comprising an electrically conductive material arranged in close proximity a wicking material for conveying liquid aerosol-forming substrate to the electrically conductive material. The susceptor assembly is positioned within the alternating magnetic field. When the susceptor material is penetrated by the alternating magnetic field, the electrically conductive material is heated by at least one of Joule heating from induced eddy currents in the susceptor and hysteresis losses. The heated electrically conductive material heats the aerosol-forming substrate, causing volatile compounds to be released from the aerosol-forming substrate, which cool to form an inhalable aerosol.

Some aerosol-generating systems comprise an aerosol-generating device and a cartridge that is configured to be used with the device. When the aerosol-generating system comprises an aerosol-generating device and a cartridge, the susceptor assembly may form part of the cartridge.

It would be desirable to provide a susceptor assembly for an aerosol-generating system with improved efficiency of heating the liquid aerosol-forming substrate.

According to an aspect of the present invention, there is provided a susceptor assembly for an aerosol-generating system. The susceptor assembly may comprise an array of filaments of a wicking material for conveying liquid aerosol-forming substrate. The array of filaments may form a mesh. The susceptor assembly may comprise at least one filament of an electrically conductive material heatable by penetration with an alternating magnetic field, wherein the at least one filament of the electrically conductive material may be wrapped around and in contact with a first filament of the array of filaments of the wicking material.

Typically, a susceptor assembly for a liquid aerosol-forming substrate requires a mesh wicking layer formed by wicking material and an electrically conductive layer formed by an electrically conductive material. In such a configuration, the contact between the wicking layer and electrically conductive layer will directly impact the amount and efficiency of aerosol generation. In the present disclosure, the electrically conductive material may not form a layer separate from the wicking material. By wrapping the electrically conductive material around a filament of the wicking material, the contact between the wicking material and electrically conductive material may be improved, thus improving aerosol generation. The improved contact between the wicking material and the electrically conductive material may also reduce the risk of the electrically conductive material overheating, because transfer of liquid aerosol-forming substrate from the wicking material to electrically conductive material may be improved compared to systems that have separate wicking and electrically conductive layers.

The present invention may improve control over which area or areas of the mesh of wicking material are in contact with the electrically conductive material. For example, the at least one filament of the electrically conductive material may be in contact with only a certain region of the mesh of wicking material. This may advantageously improve control over which portion of the susceptor assembly is heated by heating of the electrically conductive material. Advantageously, the amount of conductive material required in the susceptor assembly may be reduced, leading to reduced usage of raw materials, decreasing costs and improving sustainability.

The mesh may comprise a plurality of longitudinal filaments of the wicking material which extend in a substantially longitudinal direction and a plurality of lateral filaments of the wicking material which extend in a substantially lateral direction. The at least one filament of the electrically conductive material may be wrapped around a longitudinal filament of the wicking material. Preferably, none of the plurality of lateral filaments have an electrically conductive material wrapped around them.

A first filament of the at least one filament of the electrically conductive material may be wrapped around only a first filament of the wicking material. A second filament of the at least one filament of the electrically conductive material may be wrapped around and in contact with the first filament of the wicking material. The second filament of the at least one filament of the electrically conductive material may be wrapped around only the first filament of the wicking material. Advantageously, the heat generated in the susceptor assembly may be increased by the addition of a second filament of the electrically conductive material being around and in contact with the first filament of the wicking material, compared to a single filament of the electrically conductive material only. In this way the amount of electrically conductive material in the susceptor assembly may be increased, as such the heat generated in the susceptor assembly may be increased.

The second filament of the at least one filament of the electrically conductive material may be in contact with the first filament of the electrically conductive material. For example, the first filament and the second filament of the electrically conductive material may be wrapped around the first filament of the wicking material so that they cross over each other and therefore are in physical contact with each other. For example, the second filament of electrically conductive material may be wrapped around the filament of the wicking material in an opposite direction to the wrapping direction of the first filament of the electrically conductive material. In this way, the two filaments of electrically conductive material are in contact with each other.

The second filament of the at least one filament of the electrically conductive material may be not in contact with the first filament of the electrically conductive material. For example, the first filament and the second filament of the electrically conductive material may be wrapped around the first filament of the wicking material so that they are not in physical contact with each other. For example, the second filament of electrically conductive material may be wrapped around the filament of the wicking material in the same direction as a wrapping direction of the first filament of the electrically conductive material. When an alternating magnetic field is applied to the susceptor assembly, no contact between the first filament and the second filament of the electrically conductive material may prevent hotspots occurring in the susceptor assembly. No contact between the two filaments of electrically conductive material may lead to even heat distribution along the length of the filament of wicking material.

At least one filament of the electrically conductive material may be a coil. At least one filament of the electrically conductive material may comprise a spiral shape. At least one filament of the electrically conductive material may comprise a helical shape.

The pitch of the coil may be regular. The pitch of the coil may be irregular. The pitch of the coil may decrease along an axial length of the coil. The pitch of the coil may be pre-determined to achieve the desired heat generation in the susceptor assembly.

The pitch of the coil may be between 10 micrometres and 500 micrometres. Preferably, the pitch of the coil may be between 50 micrometres and 100 micrometres.

As defined herein “pitch” of a coil is the distance travelled parallel to the axial direction of the coil, in one revolution of the coil.

A diameter of at least one filament of the electrically conductive material may be between 5 micrometres and 100 micrometres, between 8 micrometres and 100 micrometres, between 20 micrometres and 100 micrometres, between 20 micrometres and 80 micrometres, or between 20 micrometres and 50 micrometres. The diameter of all of the filaments of the electrically conductive material may be between 5 micrometres and 100 micrometres.

A diameter of filaments of the array of the wicking material may be between 5 micrometres and 100 micrometres, between 8 micrometres and 100 micrometres, between 20 micrometres and 100 micrometres, between 20 micrometres and 800 micrometres, or between 20 micrometres and 50 micrometres. The filaments of the mesh may have a diameter of 50 micrometres. A diameter of all of the filaments of the array of the wicking material may be between 5 micrometres and 100 micrometres.

The filaments of the array of the wicking material may have any suitable cross-section. For example, the filaments may have a round cross-section or may have a flattened cross-section.

The susceptor assembly may be fluid permeable. The susceptor assembly may comprise a heating region. The heating region may comprise the least one filament of the electrically conductive material.

The susceptor assembly may comprise at least one mounting region. The at least one mounting region may comprise a portion of the array of filaments of a wicking material. The electrically conductive material may be absent from the at least one mounting region. The at least one mounting region may consist of the wicking material.

The at least one mounting region may be at a periphery of the susceptor assembly. The at least one mounting region may be at a periphery of the heating region. Preferably, the heating region may be a central region of the susceptor assembly and the at least one mounting region may be a periphery region of the susceptor assembly. The array of filaments of the wicking material may allow transportation of liquid aerosol-forming substrate from the at least one mounting region to the heating region. The at least one mounting region may be configured to allow liquid aerosol-forming substrate to be transported to the electrically conductive material. Advantageously, liquid transport to the electrically conductive material is achieved without requiring electrically conductive material across the whole of the susceptor assembly.

The susceptor assembly may comprise a first mounting region at a first edge of the susceptor assembly. The susceptor assembly may comprise a second mounting region at a second edge of the susceptor assembly, opposite the first edge. The heating region may be positioned between the first mounting region and the second mounting region. The first and second mounting regions may allow transportation of liquid aerosol-forming substrate from a liquid reservoir to the heating region. The first and second mounting regions may allow transportation of liquid aerosol-forming substrate from a liquid reservoir to the at least one filaments of the electrically conductive material.

At least one mounting region may have a rectangular cross-section. The susceptor assembly may have a rectangular cross-section. The susceptor assembly may have a cross-shaped cross-section.

The wicking material may be electrically non-conductive. The wicking material may be a non-magnetic material. Advantageously, the wicking material does not contribute to inductive heat generation within the susceptor assembly.

The heating region may be configured to heat to a substantially higher temperature than the mounting region in the presence of an alternating magnetic field. This may be due to material differences between the heating region and the mounting region, geometric differences between the heating region and the mounting region, or both material and geometric differences. For example, this may be due to the heating region comprising the filaments of the electrically conductive material, whereas the mounting region may comprise only filaments of the wicking material.

The wicking material may comprise a hydrophilic material. The wicking material may comprise an oleophilic material. This may advantageously encourage the transport of the aerosol-forming substrate through the susceptor assembly.

The wicking material may comprise a cellulosic material. The wicking material may comprise rayon. The wicking material may comprise cotton.

The filaments of the electrically conductive material may be heatable by at least one of Joule heating through induction of eddy currents in the electrically conductive material, and hysteresis losses. Advantageously, the filaments of the electrically conductive material may have a relative permeability between 1 and 40000. When a reliance on eddy currents for a majority of the heating is desirable, a lower permeability material may be used, and when hysteresis effects are desired then a higher permeability material may be used. Preferably, the material has a relative permeability between 500 and 40000. This may provide for efficient heating of the filaments of electrically conductive material.

The electrically conductive material may be a magnetic material. The term “magnetic material” is used herein to describe a material which is able to interact with a magnetic field, including both paramagnetic and ferromagnetic materials. The first material may be any suitable magnetic material that is heatable by penetration with an alternating magnetic field.

Preferably, the electrically conductive material may comprise ferritic stainless steel. Suitable ferritic stainless steels include AISI 400 series stainless steels, such as AISI type 409, 410, 420 and 430 stainless steels. Preferably, the electrically conductive material may comprise ferritic stainless-steel 430.

The susceptor assembly may be substantially flat. Substantially flat may be defined as the susceptor assembly comprising both a width and a height much greater than a depth. The susceptor assembly may be substantially planar.

According to a second embodiment the present disclosure, there is provided a cartridge for an aerosol-generating system. The cartridge may comprise the susceptor assembly according the first embodiment of the present disclosure. In other words, the cartridge may comprise a susceptor assembly, wherein the susceptor assembly may comprise an array of filaments of a wicking material for conveying liquid aerosol-forming substrate, the array of filaments forming a mesh, and at least one filament of an electrically conductive material heatable by penetration with an alternating magnetic field, wherein the at least one filament of the electrically conductive material may be wrapped around and in contact with a first filament of the array of filaments of the wicking material. The cartridge may comprise a liquid reservoir for holding a liquid aerosol-forming substrate in fluid communication with the susceptor assembly.

The mesh may comprise a plurality of longitudinal filaments of the wicking material which extend in a substantially longitudinal direction and a plurality of lateral filaments of the wicking material which extend in a substantially lateral direction. The at least one filament of the electrically conductive material may be wrapped around a longitudinal filament of the wicking material. Preferably, none of the plurality of lateral filaments have an electrically conductive material wrapped around them.

The liquid reservoir may be in fluid communication with the array of filaments of the wicking material of the susceptor assembly. Preferably, at least one of the plurality of lateral filaments of the wicking material may be in contact with the liquid reservoir. The liquid reservoir may be in fluid communication with the filaments of the electrically conductive material of the susceptor assembly. The filaments of the wicking material may form interstices between the filaments of the wicking material. The interstices may draw liquid aerosol-forming substrate from the liquid reservoir by capillary action. The interstices may allow liquid aerosol-forming substrate to be transported from the liquid reservoir to susceptor assembly. In particular, the interstices may allow liquid aerosol-forming substrate to be transported from the liquid reservoir to the at least one filament of the electrically conductive material. The susceptor assembly may convey liquid aerosol-forming substrate in both the lateral and longitudinal directions. The longitudinal direction may be the direction that is substantially parallel with the major axis of the susceptor assembly.

The cartridge may comprise an air inlet and an air outlet. The cartridge may comprise an airflow passage between the air inlet and the air outlet. The susceptor assembly may be positioned in the airflow passage. The susceptor assembly may at least partially span or extend across the cartridge airflow passage. The susceptor assembly may extend from one side of the cartridge airflow passage to another side of the cartridge airflow passage. During use of the cartridge, for example when connected to an aerosol-generating device, air may be drawn from the air inlet to the air outlet to form an air flow through the cartridge airflow passage and across a surface of the susceptor assembly. The airflow may entrain vapour of the aerosol-forming substrate that has been generated by the susceptor assembly. In the airflow passage, the vapour may cool and condense to an aerosol. The longitudinal direction of the filaments may be substantially parallel to the direction of the airflow across the susceptor assembly.

The cartridge may further comprise a susceptor holder for mounting the susceptor assembly. The susceptor holder may at least partially define the cartridge airflow passage. The susceptor holder may be coupled to the susceptor assembly.

The susceptor holder may be in contact with at least one filament of the wicking material. The susceptor holder may not be in contact with any of the filaments of the electrically conductive material. Advantageously, this minimises heat transfer to the susceptor holder. The filaments of the wicking material may not be directly heated by the induction of eddy currents, or hysteresis losses when the susceptor assembly is exposed to an alternating magnetic field. As a result, the filaments of the wicking material in contact with a susceptor holder transfer less heat to the susceptor holder than if the filaments were comprised of an electrically conductive material.

As described above, the susceptor assembly may comprise a heating region, a first mounting region and a second mounting region. In the cartridge, the heating region may be positioned in the centre of the airflow passage. The heating region may be positioned near or in the axial centre of the airflow passage.

The susceptor holder may contact the susceptor assembly at the at least one mounting region. For example, the susceptor holder may be in contact with the first mounting region and the second mounting region. The first and second mounting regions may be arranged to transport liquid aerosol-forming substrate from the liquid reservoir to the electrically conductive material. The susceptor holder may not be in physical contact with the at least one heating region. Advantageously, this may reduce heat transfer from the electrically conductive material to the susceptor holder, therefore reducing heat losses from the susceptor assembly.

The cartridge airflow passage may extend along a longitudinal axis of the cartridge. The longitudinal direction of the filaments may be parallel to the longitudinal axis of the cartridge. The cartridge may be configured to be penetrated by an alternating magnetic field in a direction parallel to longitudinal direction of the filaments. The cartridge may be couplable to an aerosol-generating device wherein the susceptor assembly may be heated by a magnetic field that penetrates the susceptor assembly in a direction parallel to the longitudinal direction of the filaments. The susceptor assembly may be configured to be penetrated by an alternating magnetic field in a direction substantially perpendicular to the direction of the alternating magnetic field. Advantageously, it has been found that in such an arrangement, electrically conductive filaments extending in the lateral direction perpendicular to the direction of the varying magnetic field contribute less significantly to heat generation by induction than electrically conductive filaments extending in the longitudinal direction would do. Therefore, because the filament of electrically conductive material may be wrapped around a longitudinal filament of the array of filaments of the wicking material, it is beneficial to dispose the susceptor assembly such that the longitudinal direction is aligned with the generated alternating magnetic field.

The cartridge may comprise a mouth end and a connection end, wherein the connection end is configured to connect the cartridge to an aerosol-generating device. The air outlet may be provided in the mouth end. The cartridge may further comprise a mouthpiece, wherein the mouthpiece comprises the air outlet.

According to a third embodiment of the invention, there is provided an aerosol-generating system. The aerosol-generating system may comprise the susceptor assembly according to the first embodiment of the present disclosure. The aerosol-generating system may comprise a liquid reservoir for holding a liquid aerosol-forming substrate in fluid communication with the susceptor assembly, and an inductor coil arranged around the susceptor assembly to generate an alternating magnetic field that penetrates the susceptor assembly for heating the electrically conductive material. The aerosol-generating system may comprise control circuitry connected to the inductor coil and configured to provide a current to the inductor coil.

The liquid reservoir may be in fluid communication with the array of filaments of the wicking material of the susceptor assembly. Preferably, at least one of the plurality of lateral filaments of the wicking material may be in contact with the liquid reservoir. The liquid reservoir may be in fluid communication with the filaments of the electrically conductive material of the susceptor assembly. The filaments of the wicking material may form interstices between the filaments of the wicking material. The interstices may draw liquid aerosol-forming substrate from the liquid reservoir by capillary action. The interstices may allow liquid aerosol-forming substrate to be transported from the liquid reservoir to susceptor assembly. In particular, the interstices may allow liquid aerosol-forming substrate to be transported from the liquid reservoir to the at least one filament of the electrically conductive material. The susceptor assembly may convey liquid aerosol-forming substrate in both the lateral and longitudinal directions. The longitudinal direction may be the direction that is substantially parallel with the major axis of the susceptor assembly. The longitudinal direction may be substantially parallel to a longitudinal axis of the aerosol-generating system.

The aerosol-generating system may comprise an air inlet and an air outlet. The aerosol-generating system may comprise an airflow passage between the air inlet and air outlet. The susceptor assembly may be positioned in the airflow passage. The susceptor assembly may at least partially span or extend across the aerosol-generating system airflow passage. The susceptor assembly may extend from one side of the aerosol-generating system airflow passage to another side of the aerosol-generating system airflow passage. During use, air may be drawn from the air inlet to the air outlet to form an air flow through the airflow passage and across a surface of the susceptor assembly. The airflow may entrain vapour of the aerosol-forming substrate that has been generated by the susceptor assembly. In the airflow passage, the vapour may cool and condense to an aerosol. The longitudinal direction of the plurality of longitudinal filaments may be substantially parallel to the direction an air flow across a surface of the susceptor assembly in use. The lateral direction of the plurality of lateral filaments may be substantially perpendicular to the direction an air flow across a surface of the susceptor assembly in use.

The aerosol-generating system may comprise a susceptor holder for mounting the susceptor assembly. The susceptor holder may be coupled to the susceptor assembly.

The susceptor holder may be in contact with at least one filament of the wicking material. The susceptor holder may be not in contact with the electrically conductive material. Advantageously, this minimises heat transfer to the susceptor holder. Preferably, the filaments of the wicking material are not comprised of an electrically conductive material, so the filaments of the wicking material are not directly heated by the induction of eddy currents, or hysteresis losses when the susceptor assembly is exposed to an alternating magnetic field. As a result, the filaments of the wicking material in contact with a susceptor holder transfer less heat to the susceptor holder than if the filaments were comprised of an electrically conductive material.

As described above, the susceptor assembly may comprise a heating region, a first mounting region and a second mounting region. In the aerosol-generating system, the heating region may be positioned in the centre of the airflow passage. The heating region may be positioned near or in the axial centre of the airflow passage.

The susceptor holder may contact the susceptor assembly at the at least one mounting region. For example, the susceptor holder may be in contact with the first mounting region and the second mounting region. The first and second mounting regions may be arranged to transport liquid aerosol-forming substrate from the liquid reservoir to the electrically conductive material. The susceptor holder may not be in physical contact with the at least one heating region. Advantageously, this may reduce heat transfer from the electrically conductive material to the susceptor holder, therefore reducing heat losses from the susceptor assembly.

The inductor coil may comprise a tubular coil. The inductor coil may comprise a helical coil. The inductor coil may comprise a spiral coil. Preferably, the inductor coil is both tubular and helical. Preferably, the aerosol-generating system may comprise only one helical coil. The inductor coil may be arranged to circumscribe the susceptor assembly. The inductor coil may comprise copper.

The inductor coil may be arranged to generate a magnetic field that penetrates the susceptor assembly in a direction substantially parallel to the plurality of longitudinal filaments of the wicking material. Advantageously, it has been found that electrically conductive filaments extending in the longitudinal direction parallel to the direction of the varying magnetic field contribute more significantly to power and heat generation by induction than electrically conductive filaments extending in the lateral direction would do. Therefore, it is beneficial to dispose the susceptor assembly such that the longitudinal direction is aligned with the generated alternating magnetic field.

The aerosol-generating system may comprise a power supply, such as a battery.

The system may further comprise control circuitry. The control circuitry may control a temperature of filaments of the electrically conductive material.

The control circuitry may be configured to supply an alternating current to the inductor to generate a magnetic field. The susceptor assembly may be at least partially within the magnetic field generated by the inductor coil. Filaments of the electrically conductive material may be at least partially within the magnetic field generated by the inductor coil.

When an alternating current is supplied to the inductor coil, a temperature of the heating region may increase more than a temperature of the mounting region. Advantageously, this may reduce the risk of overheating of the mounting region in particular.

The aerosol-generating system may comprise a cartridge and an aerosol-generating device. The cartridge may be couplable to the aerosol-generating device. The cartridge may be a cartridge according to the second embodiment of the present disclosure. The aerosol-generating device may comprise a device airflow inlet and a device airflow outlet. The aerosol-generating device may comprise a device airflow passage extending between the device airflow inlet and the device airflow outlet. The device air outlet may be in fluid communication with the air inlet of the cartridge when the cartridge is coupled to the aerosol-generating device, such that a system airflow passage is defined between the device air inlet and the air outlet of the cartridge.

The aerosol-generating device may comprise a cavity, into which at least part of the cartridge is located when the cartridge is coupled to the aerosol-generating device. The aerosol-generating device may comprise the inductor coil and the control circuitry connected to the inductor coil.

According to a fourth embodiment of the present disclosure there is provided a method for manufacturing a susceptor assembly for an aerosol-generating system. The method may comprise providing a plurality of filaments of a wicking material for conveying liquid aerosol-forming substrate. The method may comprise wrapping at least one filament of an electrically conductive material heatable by penetration with an alternating magnetic field around at least one filament of the plurality of filaments of the wicking material. The method may further comprise assembling the plurality of filaments of the wicking material to form a mesh.

According to a fifth embodiment of the present disclosure, there is provided an aerosol-generating system. The aerosol-generating system may comprise a liquid reservoir for holding a liquid aerosol-forming substrate, and a susceptor assembly comprising a mesh. The mesh may comprise a plurality of filaments of a first material extending in a first direction and a plurality of filaments of a second material extending in a second direction. The first material may be an electrically conductive material heatable by penetration with an alternating magnetic field and the second material may be a wicking material for conveying liquid from the liquid reservoir to the susceptor assembly. The aerosol-generating system may further comprise an inductor coil arranged around the susceptor assembly to generate an alternating magnetic field for penetrating the susceptor assembly in a direction substantially parallel to the first direction, and control circuitry connected to the inductor coil and configured to provide current to the inductor coil.

Typically, a susceptor assembly for a liquid aerosol-forming substrate requires a mesh wicking layer formed by wicking material and an electrically conductive layer formed by an electrically conductive material. In such a configuration, the contact between the wicking layer and electrically conductive layer will directly impact the amount and efficiency of aerosol generation. In the present invention, the electrically conductive material may not form a layer separate from the wicking material. As such, the contact between the wicking material and electrically conductive material may be improved, thus improving aerosol generation. The improved contact between the wicking material and the electrically conductive material may also reduce the risk of the electrically conductive material overheating because transfer of liquid aerosol-forming substrate from the wicking material to electrically conductive material may be improved compared to systems that have separate wicking and electrically conductive layers.

During penetration of a susceptor assembly by an alternating magnetic field, wherein the electrically conductive layer consists of filaments of an electrically conductive material, it has been found that filaments of an electrically conductive material that extend in the first direction parallel to the direction of the alternating magnetic field contribute more significantly to heat generation by induction than filaments of an electrically conductive material that do not extend parallel to the direction of the alternating magnetic field.

The first direction is a different direction to the second direction. By providing conductive material extending in the first direction and wicking material in the second direction, sufficient heating can be achieved by the filaments of electrically conductive material that extend in the first direction and the amount of electrically conductive material required in the susceptor assembly may be reduced, leading to reduced usage of raw materials, decreasing costs and improving sustainability.

The first direction may be substantially perpendicular to second direction. Advantageously, this provides a susceptor assembly that has a stable structure and provides good transport of liquid from the liquid reservoir to the susceptor assembly.

A diameter of each of the plurality of filaments of the first material may be between 5 micrometres and 100 micrometres, between 20 micrometres and 100 micrometres, between 20 micrometres and 80 micrometres, or between 20 micrometres and 50 micrometres.

A diameter of the each of the plurality of filaments of the second material may be between 5 micrometres and 100 micrometres, between 20 micrometres and 100 micrometres, between 20 micrometres and 80 micrometres, or between 20 micrometres and 50 micrometres.

Each of the plurality of filaments of the first material may have any suitable cross-section. Each of the plurality of filaments of the second material may have any suitable cross-section. For example, the filaments may have a round cross-section or may have a flattened cross-section.

The susceptor assembly may be fluid permeable.

The liquid reservoir may be in fluid communication with the plurality of filaments of the second material of the susceptor assembly. The wicking material may be arranged to convey liquid from the liquid reservoir to the susceptor assembly. The at least some of the plurality of lateral filaments of the second material may be in contact with the liquid reservoir. The liquid reservoir may be in fluid communication with the plurality of filaments of the second material. The at least some of the plurality of lateral filaments of the second material may extend into the liquid reservoir.

The interstices may draw liquid aerosol-forming substrate from the liquid reservoir by capillary action. The interstices may allow liquid aerosol-forming substrate to be transported from the liquid reservoir to susceptor assembly. In particular, the interstices may allow liquid aerosol-forming substrate to be transported from the liquid reservoir to the plurality of filaments of the first material. The susceptor assembly may convey liquid aerosol-forming substrate in both the first and second directions. The first direction may be substantially parallel with a major axis of the susceptor assembly. The first direction may be substantially parallel to a longitudinal axis of the aerosol-generating system.

The susceptor assembly may comprise a heating region. The heating region may comprise the plurality of filaments of the first material.

The susceptor assembly may comprise at least one mounting region. The at least one mounting region may comprise some of the plurality of filaments of the second material. Filaments of the first material may be absent from the at least one mounting region. The at least one mounting region may consist of filaments of the second material.

The at least one mounting region may be at a periphery of the susceptor assembly. The at least one mounting region may be at a periphery of the heating region. Preferably, the heating region may be a central region of the susceptor assembly and the at least one mounting region may be a periphery region of the susceptor assembly. The plurality of filaments of the second material may allow transportation of liquid aerosol-forming substrate from the at least one mounting region to the heating region. The at least one mounting region may be arranged to transport liquid aerosol-forming substrate from the liquid reservoir to the heating region.

The susceptor assembly may comprise a first mounting region at a first edge of the susceptor assembly. The susceptor assembly may comprise a second mounting region at a second edge of the susceptor assembly, opposite the first edge. The heating region may be positioned between the first mounting region and the second mounting region.

The susceptor assembly may comprise a first mounting region at a first edge of the susceptor assembly. The susceptor assembly may comprise a second mounting region at a second edge of the susceptor assembly, opposite the first edge. The heating region may be positioned between the first mounting region and the second mounting region. The first and second mounting regions may allow transportation of liquid aerosol-forming substrate from the liquid reservoir to the heating region.

The at least one mounting region may have a rectangular cross-section. The susceptor assembly may have a rectangular cross-section. The susceptor assembly may have a cross-shaped cross-section.

The second material may be electrically non-conductive. The second material may be a non-magnetic material. Advantageously, the second material does not contribute to heat generation within the susceptor assembly.

The heating region may be configured to heat to a substantially higher temperature than the mounting region in the presence of an alternating magnetic field. This may be due to material differences between the heating region and the mounting region, geometric differences between the heating region and the mounting region, or both material and geometric differences. For example, this may be due to the heating region comprising the electrically conductive first material whereas the mounting region may comprise the wicking material. Alternatively or in addition, this may be due to the first material extending in a first direction that is substantially parallel to the magnetic field generated by the inductor whereas the mounting region may comprise the wicking second material which may extend in a second direction that is not substantially parallel to the magnetic field generated by the inductor and is not heated by an alternating magnetic field.

The second material may comprise a hydrophilic material. The second material may comprise an oleophilic material. Advantageously, providing a hydrophilic second material or an oleophilic second material may encourage the transport of the aerosol-forming substrate through the susceptor assembly.

The second material may comprise a cellulosic material. The second material may comprise rayon. The second material may comprise cotton.

The plurality of filaments of the first material may be heatable by at least one of Joule heating through induction of eddy currents in the first material and hysteresis losses. Advantageously, the first material may have a relative permeability between 1 and 40000. When a reliance on eddy currents for a majority of the heating is desirable, a lower permeability material may be used, and when hysteresis effects are desired then a higher permeability material may be used. Preferably, the material has a relative permeability between 500 and 40000. This may provide for efficient heating of the first material.

The first material may be a magnetic material. The first material may be any suitable magnetic material that is heatable by penetration with an alternating magnetic field. Preferably, the first material may comprise a ferritic stainless steel. The first material may comprise ferritic stainless-steel 430. The first material may comprise other suitable ferritic stainless steels, which include AISI 400 series stainless steels, such as AISI type 409, 410, and 420 stainless steels.

The mesh may be formed using different types of weave or lattice structures. The mesh may be a woven mesh. At least one of the plurality of filaments of the second material may be woven over and under alternate filaments of the first material. This alternating weave may contribute to an even heat distribution across the susceptor assembly.

At least one of the plurality of filaments of the second material may be woven over one or more filaments of first material and then woven under one or more filaments of second material. Advantageously, this may improve the structural integrity of the susceptor assembly.

The aerosol-generating system may comprise an air inlet and an air outlet. The aerosol-generating system may comprise an airflow passage between the air inlet and air outlet. The susceptor assembly may be positioned in the airflow passage. The susceptor assembly may at least partially span or extend across the aerosol-generating system airflow passage. The susceptor assembly may extend from one side of the aerosol-generating system airflow passage to another side of the aerosol-generating system airflow passage. During use, air may be drawn from the air inlet to the air outlet to form an air flow through the airflow passage and across a surface of the susceptor assembly. The airflow may entrain vapour of the aerosol-forming substrate that has been generated by the susceptor assembly. In the airflow passage, the vapour may cool and condense to an aerosol. The first direction may be substantially parallel to the direction an air flow across a surface of the susceptor assembly in use. The second direction of may be substantially perpendicular to the direction an air flow across a surface of the susceptor assembly in use. The first direction may be substantially parallel to a longitudinal direction of the airflow passage. The second direction may be substantially perpendicular to a longitudinal direction of the airflow passage.

When the susceptor assembly comprises a heating region and at least one mounting region, the heating region may be positioned in the centre of the airflow passage. The heating region may be positioned near or in the axial centre of the airflow passage.

The aerosol-generating system may comprise a susceptor holder for mounting the susceptor assembly. The susceptor holder may be coupled to the susceptor assembly.

The susceptor holder may be in contact with at least one filament of the second material. The susceptor holder may be not in contact with any of the plurality of filaments of the first material. Advantageously, this minimises heat transfer to the susceptor holder.

The susceptor assembly may be substantially planar. The susceptor assembly may define a plane. The planar susceptor assembly may comprise a first side and opposing second side. Both the first side and the second side of the susceptor assembly may be exposed to the airflow passage. In use, air may be drawn across both the first side and the second side of the susceptor assembly, which may therefore allow entrainment of aerosol-generating substrate from both sides of the susceptor assembly. Advantageously, this may improve the entrainment of aerosol-generating substrate compared to a susceptor assembly comprising only one side exposed to an airflow passage.

The filaments of the first material and the filaments of the second material may be woven together so that the filaments of the second material, which extend in the second direction, extend further outwards from the plane of the susceptor assembly than the filaments extending in the first direction. In other words, the filaments extending in the second direction define the maximum thickness of the woven mesh. As the filaments extending in the second direction define the maximum thickness of the susceptor woven mesh of the susceptor assembly, the susceptor holder may contact filaments of the second material only. Preferably, the filaments of the second material are not comprised of an electrically conductive material, so the filaments of the second material may not be directly heated by the induction of eddy currents, or hysteresis losses when the susceptor assembly is exposed to an alternating magnetic field. As a result, the second filaments in contact with a susceptor holder transfer less heat to the susceptor holder than if the filaments were comprised of the first material.

The susceptor holder may contact the susceptor assembly at the at least one mounting region. For example, the susceptor holder may be in contact with the first mounting region and the second mounting region. The first and second mounting regions may be arranged to transport liquid aerosol-forming substrate from the liquid reservoir to the filaments of the second material. The susceptor holder may not be in physical contact with the at least one heating region. Advantageously, this may reduce heat transfer from the second material to the susceptor holder, therefore reducing heat losses from the susceptor assembly.

The inductor coil may comprise a tubular coil. The inductor coil may comprise a helical coil. Preferably, the inductor coil is both tubular and helical. The inductor may comprise at least one helical coil. Preferably, the inductor may comprise only one helical coil. The inductor coil may comprise a spiral coil. The inductor coil may be arranged to circumscribe the susceptor assembly. The inductor coil may comprise copper.

The aerosol-generating system may preferably comprise only one inductor coil.

The aerosol-generating system may comprise a power supply, such as a battery

The system may further comprise control circuitry. The control circuitry may control a temperature of filaments of the first material.

The control circuitry may be configured to supply an alternating current to the inductor to generate an alternating magnetic field.

The susceptor assembly may be positioned at least partially within the alternating magnetic field generated by the inductor. The plurality of filaments of the first material may be at least partially within the alternating magnetic field generated by the inductor. The alternating magnetic field generated by the inductor may be parallel to the longitudinal axis of the airflow passage.

The aerosol-generating system may comprise a mouthpiece. The mouthpiece may comprise the air outlet. The aerosol-generating system may be configured to allow a user to puff on the mouthpiece to draw an aerosol through the air outlet.

The aerosol-generating system may comprise a cartridge and an aerosol-generating device.

The cartridge may comprise the susceptor assembly and the liquid reservoir. The cartridge may comprise the air inlet, the air outlet and the airflow passage. The cartridge may be couplable to the device.

The aerosol-generating device may comprise the inductor coil and the control circuitry. The device may comprise a device air inlet and a device air outlet, with a device airflow passage defined therebetween. The device air outlet may be couplable to the air inlet of the cartridge.

The following features may apply to any of the embodiments of the present disclosure.

As used herein the term “mesh” encompasses grids and arrays of filaments having spaces therebetween. The term mesh may include woven and non-woven fabrics. The mesh may define interstices between the filaments and the interstices may have a width of between 10 micrometres and 100 micrometres. Preferably the filaments give rise to capillary action in the interstices, so that in use, the aerosol-forming liquid is drawn into the interstices, increasing the contact area between the mesh and the liquid.

The filaments of the mesh may form a mesh of size between 160 and 600 Mesh US 5 (+/−10%) (i.e. between 160 and 600 filaments per inch (+/−10%)). The width of the interstices may be between 35 micrometres and 140 micrometres, or between 25 micrometres and 75 micrometres. For example, the width of the interstices may be 40 micrometres, or 63 micrometres. The percentage of open area of the mesh, which is the ratio of the area of the interstices to the total area of the mesh is preferably between 25 and 56%.

The mesh may be a woven mesh. The mesh may be formed using different types of weave or lattice structures. The mesh may be fluid permeable.

As used herein a “fluid permeable” mesh means a mesh that allows liquid or gas to permeate through it. In particular, the mesh may allow the aerosol-forming substrate, in either gaseous phase or both gaseous and liquid phase, to permeate through it.

The susceptor holder may comprise a thermally insulative material. The susceptor holder may comprise an electrically insulative material. The susceptor holder may comprise at least one polymer. The susceptor holder may comprise polyether ether ketone (PEEK). The susceptor holder may be formed by injection moulding. Advantageously, injection moulding may simplify manufacturing aerosol-generating system.

As use herein, a “wicking material” is a material that does not heat up in an alternating magnetic field and can be used to form a mesh for conveying liquid aerosol-forming substrate.

As used herein with reference to the invention, the term “aerosol” is used to describe a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, an “aerosol-generating system” means a system that generates an aerosol from one or more aerosol-forming substrates.

As used herein, an “aerosol-generating device” may mean a device that generates an aerosol from one or more aerosol-forming substrates. The “aerosol-generating device” may be configured to generate an aerosol from one or more aerosol-forming substrates when a cartridge comprising the one or more aerosol-forming substrates is coupled to the “aerosol-generating device”.

As used herein, the term “aerosol-forming substrate” means a substrate capable of releasing volatile compounds that may form an aerosol. Such volatile compounds may be released by heating the aerosol-forming substrate.

As used herein, the term “puff” is used to describe the action of a user generating aerosol using the aerosol-generating system or device. The user carries out this action by drawing air through the aerosol-generating system or device by inhalation.

As used herein, the term “session” refers to a period in which the aerosol-generating system or device is activated, for example by a user, and comprises at least one puff. During the session, the aerosol-generating system or device may automatically detect a puff, as described above, and power heat the heating susceptor assembly accordingly.

As used herein, the terms “air inlet’ and ‘air outlet” are used to describe one or more apertures through which air may be drawn into, and out of, respectively, of a component or portion of a component of the cartridge, aerosol-generating system or aerosol-generating device.

As used herein, the term “cartridge” also refers to an article comprising an aerosol-forming substrate that is capable of releasing volatile compounds that can form an aerosol. A cartridge may be disposable.

The aerosol-forming substrate may comprise both liquid and solid components. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours. The liquid aerosol-forming substrate may comprise nicotine and at least one aerosol former. The aerosol former may be glycerine or propylene glycol. The aerosol former may comprise both glycerine and propylene glycol. The liquid aerosol-forming substrate may have a nicotine concentration of between about 0.5% and about 10%, for example about 2%.

The aerosol-generating system may be a handheld aerosol-generating system. The aerosol-generating system may be a handheld aerosol-generating system configured to allow a user to suck on a mouthpiece to draw an aerosol through a first air outlet. The aerosol-generating system may have a size comparable to a conventional cigar or cigarette. The aerosol-generating system may have a total length between about 25 mm and about 150 mm. The aerosol-generating system may have an external diameter between about 5 mm and about 30 mm.

The power supply may be a DC power supply. The power supply may be a battery. The battery may be a Lithium based battery, for example a Lithium-Cobalt, a Lithium-Iron-Phosphate, a Lithium Titanate or a Lithium-Polymer battery. The battery may be a Nickel metal hydride battery or a Nickel cadmium battery. The power supply may be another form of charge storage device such as a capacitor.

The control circuitry may be configured to control the supply of power from the battery to the inductor. Advantageously, different power profiles may be supplied to the inductor by the control circuitry dependent on the aerosol generation required. The control circuitry may further comprise a puff detector. The puff detector may be configured to be in fluid communication with the airflow passage. The aerosol-generating system may be configured such that the power supplied to the inductor is based on a signal from the puff detector. Advantageously, power may then only be supplied to the inductor by the control circuitry when the user is puffing on the aerosol-generating system. The control circuitry may comprise a microcontroller. The microcontroller may be a programmable microcontroller.

The invention is defined in the claims. However, below there is provided a non-exhaustive list of non-limiting examples. Any one or more of the features of these examples may be combined with any one or more features of another example, embodiment, or aspect described herein.

Ex1. A susceptor assembly for an aerosol-generating system, the susceptor assembly comprising: an array of filaments of a wicking material for conveying liquid aerosol-forming substrate, the array of filaments forming a mesh; and
at least one filament of an electrically conductive material heatable by penetration with an alternating magnetic field, wherein the at least one filament of the electrically conductive material is wrapped around and in contact with a first filament of the array of filaments of the wicking material.

Ex2. The susceptor assembly according to Ex1, wherein the mesh comprises a plurality of longitudinal filaments of the wicking material which extend in a substantially longitudinal direction and a plurality of lateral filaments of the wicking material which extend in a substantially lateral direction.

Ex3. The susceptor assembly according to Ex2, wherein the at least one filament of the electrically conductive material is wrapped around a longitudinal filament of the wicking material.

Ex4. The susceptor assembly according to any of Ex1 to Ex3, wherein a first filament of the at least one filaments of the electrically conductive material is wrapped around only a first filament of the wicking material.

Ex5. The susceptor assembly according to any of Ex1 to Ex4, wherein a second filament of the at least one filaments of the electrically conductive material is wrapped around and in contact with the first filament of the wicking material.

Ex6. The susceptor assembly according to Ex5, wherein the second filament of the at least one filaments of the electrically conductive material is wrapped around only the first filament of the wicking material.

Ex7. The susceptor assembly according to Ex5 or Ex6, wherein the second filament of the at least one filaments of the electrically conductive material is in contact with the first filament of the electrically conductive material.

Ex8. The susceptor assembly according to Ex5 or Ex6, wherein the second filament of the at least one filaments of the electrically conductive material is not in contact with the first filament of the electrically conductive material.

Ex9. The susceptor assembly according to any of Ex1 to Ex8, wherein at least one filament of the electrically conductive material is a coil.

Ex10. The susceptor assembly according to Ex9, wherein at least one filament of the electrically conductive material comprises a spiral shape.

Ex11. The susceptor assembly according to Ex9 or Ex10, wherein at least one filament of the electrically conductive material comprises a helical shape.

Ex12. The susceptor assembly according to any one of Ex9 to Ex11, wherein the pitch of the coil is regular.

Ex13. The susceptor assembly according to any one of Ex9 to Ex11, wherein the pitch of the coil is irregular.

Ex14. The susceptor assembly according to Ex13, wherein the pitch of the coil decreases along an axial length of the coil.

Ex15. The susceptor assembly according to any of Ex12 to Ex14, wherein the pitch is between 10 micrometres and 500 micrometres, preferably between 50 micrometres and 100 micrometres.

Ex16. The susceptor assembly according to any of Ex1 to Ex15, wherein a diameter of at least one filament of electrically conductive material is between 20 micrometres and 100 micrometres, preferably 50 micrometres.

Ex17. The susceptor assembly according to any of Ex1 to Ex16, wherein a diameter of filaments of the array of the wicking material have a diameter of 20 micrometres and 100 micrometres, preferably 50 micrometres.

Ex18. The susceptor assembly according to any of Ex1 to Ex17, wherein the mesh is a woven mesh.

Ex19. The susceptor assembly according to any of Ex1 to Ex17, wherein the mesh is fluid permeable.

Ex20. The susceptor assembly according to any of Ex1 to Ex19, wherein the susceptor assembly is fluid permeable.

Ex21. The susceptor assembly according to any of Ex1 to Ex20, wherein the susceptor assembly comprises at least one mounting region and a heating region, wherein the at least one mounting region comprises the wicking material and the heating region comprises the electrically conductive material.

Ex22. The susceptor assembly according to Ex21, wherein the at least one mounting region is at a periphery of the susceptor assembly.

Ex23. The susceptor assembly according to Ex21 or Ex22, wherein the heating region comprises the wicking material.

Ex24. The susceptor assembly according to any one of Ex21 to Ex23, wherein the at least one mounting region does not contain the electrically conductive material.

Ex25. The susceptor assembly according to any of Ex1 to Ex24, wherein the susceptor assembly has a rectangular cross-section.

Ex26. The susceptor assembly according to any of Ex1 to Ex24, wherein the susceptor assembly has a cross-shaped cross-section.

Ex27. The susceptor assembly according to any of Ex1 to Ex25, wherein the mounting region has a rectangular cross-section.

Ex28. The susceptor assembly according to any one of Ex1 to Ex27, wherein the wicking material is electrically non-conductive.

Ex29. The susceptor assembly according to any one of Ex1 to Ex28, wherein the wicking material is a non-magnetic material.

Ex30. The susceptor assembly according to any one of Ex1 to Ex29, wherein the wicking material comprises a hydrophilic material.

Ex31. The susceptor assembly according to any one of Ex1 to Ex30, wherein the wicking material comprises an oleophilic material.

Ex32. The susceptor assembly according to any one of Ex1 to Ex31, wherein the wicking material comprises a cellulosic material.

Ex33. The susceptor assembly according to any one of Ex1 to Ex31, wherein the wicking material comprises rayon.

Ex34. The susceptor assembly according to any one of Ex1 to Ex33, wherein the wicking material comprises cotton.

Ex35. The susceptor assembly according to any one of Ex1 to Ex34, wherein the electrically conductive material is a magnetic material.

Ex36. The susceptor assembly according to any one of Ex1 to Ex35, wherein the electrically conductive material comprises ferritic stainless steel.

Ex37. The susceptor assembly according to any one of Ex1 to Ex36, wherein the electrically conductive material comprises ferritic stainless-steel 430.

Ex38. A cartridge for an aerosol-generating system, the cartridge comprising: the susceptor assembly according to any one of Ex1 to Ex37;
a liquid reservoir for holding a liquid aerosol-forming substrate in fluid communication with the susceptor assembly.

Ex39. The cartridge according to Ex38, wherein at least one of the plurality of lateral filaments of the wicking material is in contact with the liquid reservoir.

Ex40. The cartridge according to Ex38 or Ex39, comprising an air inlet, an air outlet and an airflow passage extending between the air inlet and air outlet.

Ex41. The cartridge according to Ex40, wherein the susceptor assembly is positioned in the airflow passage.

Ex42. The cartridge according to Ex40 or Ex41, wherein the plurality of longitudinal filaments of the wicking material are parallel to a longitudinal direction of the airflow passage.

Ex43. The cartridge according to any one of Ex40 to Ex42, wherein the plurality of lateral filaments of the wicking material are perpendicular to a longitudinal direction of the airflow passage.

Ex44. The cartridge according to any of Ex38 to Ex43, further comprising a susceptor holder for mounting the mesh.

Ex45. The cartridge according to Ex44, wherein the susceptor holder is in contact with at least one filament of the wicking material.

Ex46. The cartridge according to Ex44 or Ex45, wherein the susceptor holder is not in contact with the electrically conductive material.

Ex47. The cartridge according to any one of Ex41 to Ex46 comprising a mouth end and a connection end, wherein the connection end is configured to connect the cartridge to an aerosol-generating device.

Ex48. The cartridge according to example Ex47, wherein the air outlet is provided in the mouth end.

Ex49. The cartridge according to any one of examples Ex43 to Ex48, further comprising a mouthpiece, wherein the mouthpiece comprises the air outlet.

Ex50. An aerosol-generating system comprising:
the susceptor assembly according to any one of examples Ex1 to Ex40;
a liquid reservoir for holding a liquid aerosol-forming substrate in fluid communication with the susceptor assembly; and
an inductor coil arranged around the susceptor assembly to generate an alternating magnetic field that penetrates the susceptor assembly for heating the electrically conductive material; and
control circuitry connected to the inductor coil and configured to provide a current to the inductor coil.

Ex51. The aerosol-generating system according to Ex50, wherein the inductor coil comprises a helical coil.

Ex52. The aerosol-generating system according to Ex50 or Ex51, wherein the inductor coil is arranged to circumscribe the susceptor assembly.

Ex53. The aerosol-generating system according to any of Ex50 to Ex52, wherein the inductor coil is arranged to generate an alternating magnetic field that penetrates the susceptor assembly in a direction substantially parallel to the plurality of longitudinal filaments of the wicking material.

Ex54. A method for manufacturing a susceptor assembly for an aerosol-generating system, the method comprising:
providing a plurality of filaments of a wicking material for conveying liquid aerosol-forming substrate;
wrapping at least one filament of an electrically conductive material heatable by penetration with an alternating magnetic field around at least one filament of the plurality of filaments of the wicking material; and
assembling the plurality of filaments of the wicking material to form a mesh.

Ex55. An aerosol-generating system comprising:
a liquid reservoir for holding a liquid aerosol-forming substrate;
a susceptor assembly comprising a mesh, the mesh comprising a plurality of filaments of a first material extending in a first direction and a plurality of filaments of a second material extending in a second direction, wherein the first material is an electrically conductive material heatable by penetration with an alternating magnetic field and the second material is a wicking material for conveying liquid from the liquid reservoir to the susceptor assembly;
an inductor coil arranged around the susceptor assembly to generate an alternating a magnetic field for penetrating the susceptor assembly in a direction substantially parallel to the first direction; and
control circuitry connected to the inductor coil and configured to provide current to the inductor coil.

Ex56. The aerosol-generating system according to Ex55, wherein the first direction is substantially perpendicular to second direction.

Ex57. The aerosol-generating system according to any one of Ex55 to Ex56, wherein the inductor coil comprises a tubular coil.

Ex58. The aerosol-generating system according to any one of Ex55 to Ex57, wherein the inductor coil comprises a helical coil.

Ex59. The aerosol-generating system according to any one of Ex55 to Ex58, wherein the inductor coil comprises a spiral coil.

Ex60. The aerosol-generating system according to any one of Ex55 to Ex59, the inductor coil is arranged to circumscribe the susceptor assembly.

Ex61. The susceptor assembly according to any of Ex55 to Ex60, wherein the susceptor assembly is fluid permeable.

Ex62. The aerosol-generating system according to any of Ex55 to Ex61, wherein the mesh is substantially planar.

Ex63. The aerosol-generating system according to any of Ex55 to Ex62, wherein at least one of the plurality of filaments of the second material is in contact with the liquid reservoir.

Ex64. The aerosol-generating system according to any one of Ex55 to Ex63, wherein the mesh comprises heating region and at least one mounting region, wherein heating region comprises the first material and the at least mounting region comprises the second material.

Ex65. The aerosol-generating system according to Ex64, wherein the at least one mounting region is at a periphery of the heating region.

Ex66. The aerosol-generating system according to Ex64 or Ex65, wherein the heating region comprises the second material.

Ex67. The aerosol-generating system according to any one of Ex64 to Ex66, wherein the at least one mounting region does not contain the first material.

Ex68. The susceptor assembly according to any of Ex64 to Ex67, wherein at least one mounting region has a rectangular cross-section.

Ex69. The aerosol-generating system according to any one of Ex55 to Ex68, wherein the susceptor assembly has a rectangular cross-section.

Ex70. The aerosol-generating system according to any one of Ex55 to Ex69, wherein the susceptor assembly has a cross-shaped cross-section.

Ex71. The aerosol-generating system according to any one of Ex55 to Ex70, wherein the second material is electrically non-conductive.

Ex72. The aerosol-generating system according to any one of Ex55 to Ex71, wherein the second material is a non-magnetic material.

Ex73. The aerosol-generating system according to any one of Ex55 to Ex72, wherein the second material comprises a hydrophilic material.

Ex74. The aerosol-generating system according to any one of Ex55 to Ex73, wherein the second material comprise an oleophilic material.

Ex75. The aerosol-generating system according to any one of Ex55 to Ex74, wherein the second material comprises a cellulosic material.

Ex76. The aerosol-generating system according to any one of Ex55 to Ex75, wherein the second material comprises rayon.

Ex77. The aerosol-generating system according to any one of Ex55 to Ex76, wherein the second material comprises cotton.

Ex78. The aerosol-generating system according to any one of Ex55 to Ex77, wherein the first material is a magnetic material.

Ex79. The aerosol-generating system according to any one of Ex55 to Ex78, wherein the first material comprises ferritic stainless steel.

Ex80. The aerosol-generating system according to any one of Ex55 to Ex79, wherein the first material comprises ferritic stainless-steel 430.

Ex81. The aerosol-generating system according to any one of Ex55 to Ex79, wherein the mesh is woven.

Ex82. The aerosol-generating system according to Ex81 wherein at least one of the plurality of filaments of the second material is woven over and under alternate filaments of the first material.

Ex83. The aerosol-generating system according to Ex81 or Ex82, wherein at least one of the plurality of filaments of the second material is woven over one or more filaments of first material and then woven under one or more filaments of second material.

Ex84. The aerosol-generating system according to any one of Ex55 to Ex83, comprising a susceptor holder for mounting the susceptor assembly.

Ex85. The aerosol-generating system according to Ex84, wherein the susceptor holder is in contact with at least one filament of the second material.

Ex86. The susceptor assembly according to Ex84 or Ex85, wherein the susceptor holder is not in contact with the first material.

Ex87. The aerosol-generating system according to any one of Ex55 to Ex86, comprising an air inlet, an air outlet and an airflow passage between the air inlet and the air outlet.

Ex88. The aerosol-generating system according to Ex87, wherein at least a portion of the susceptor assembly is positioned within the airflow passage.

Ex89. The aerosol-generating system according to Ex87 or Ex88, wherein the plurality of filaments of a first material are positioned within the airflow passage.

Ex90. The aerosol-generating system according to any one of Ex87 to Ex89, wherein the first direction is substantially parallel to a longitudinal direction of the airflow passage.

Ex91. The aerosol-generating system according to any one of Ex87 to Ex90, wherein the second direction is substantially perpendicular to a longitudinal direction of the airflow passage.

Ex92. The aerosol-generating system according to any one of Ex87 to Ex91, comprising a mouthpiece, wherein the mouthpiece comprises the air outlet.

Examples will now be further described with reference to the figures in which:

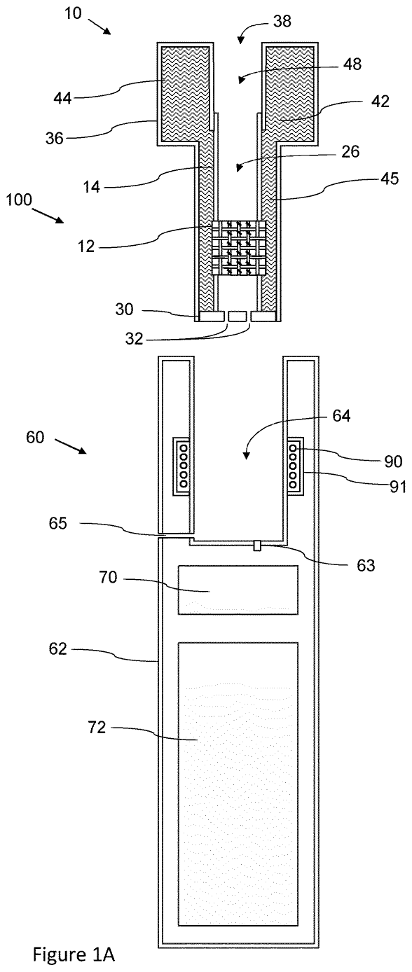

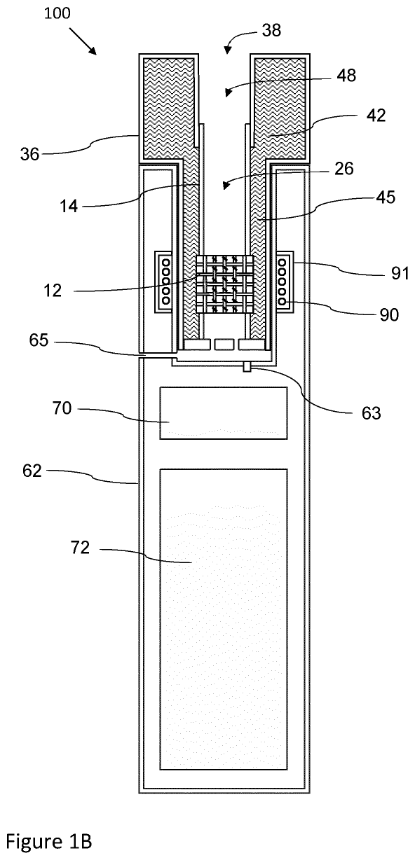

FIG. 1A shows a schematic illustration of a cross-section of an aerosol-generating system comprising a first example of a susceptor assembly according to the present disclosure;

FIG. 1B shows a schematic illustration of a cross-section of the aerosol-generating system of FIG. 1A in a use configuration;

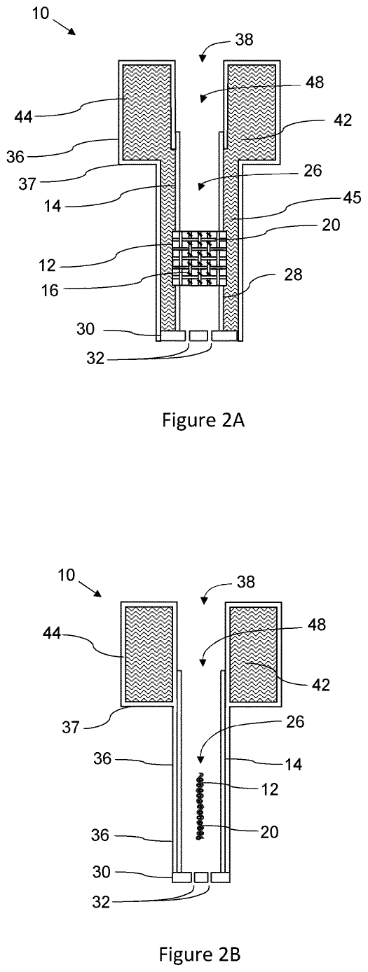

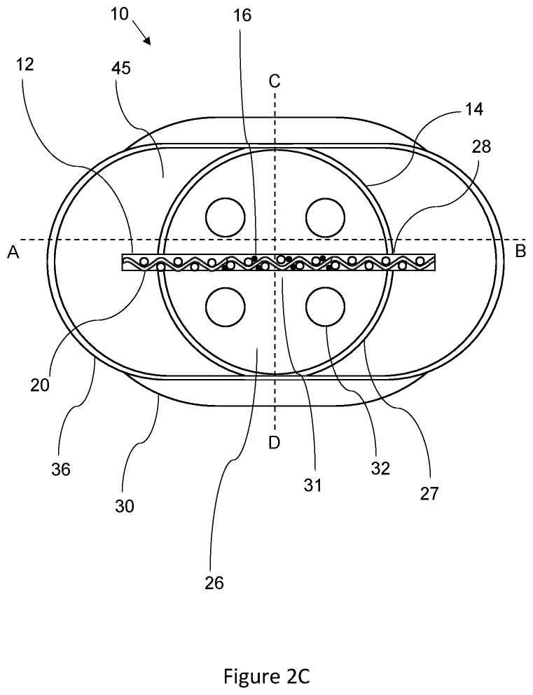

FIG. 2A shows a schematic illustration of a cross-section of a cartridge comprising the first example of a susceptor assembly;

FIG. 2B shows a schematic illustration of an alternative cross-section of the cartridge of FIG. 2A;

FIG. 2C shows a schematic illustration of a further alternative cross-section of the cartridge of FIGS. 2A and 2B;

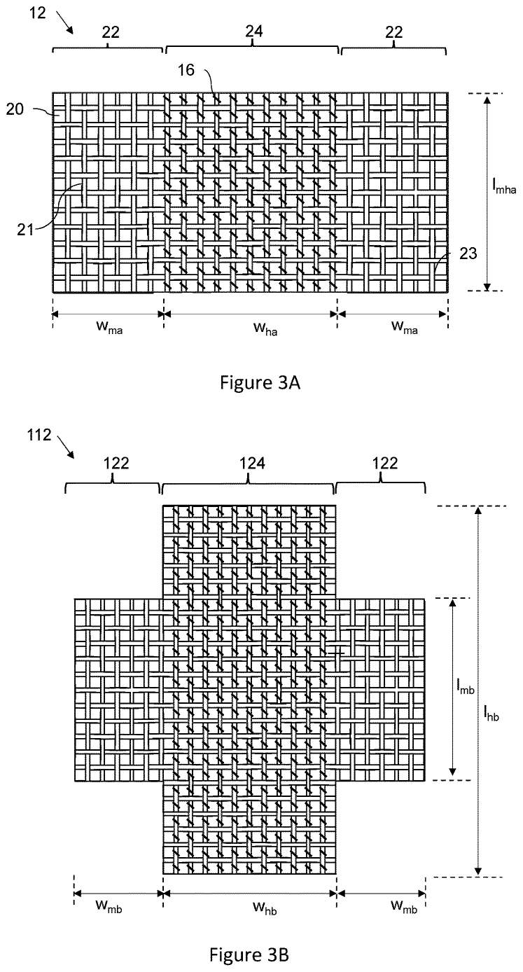

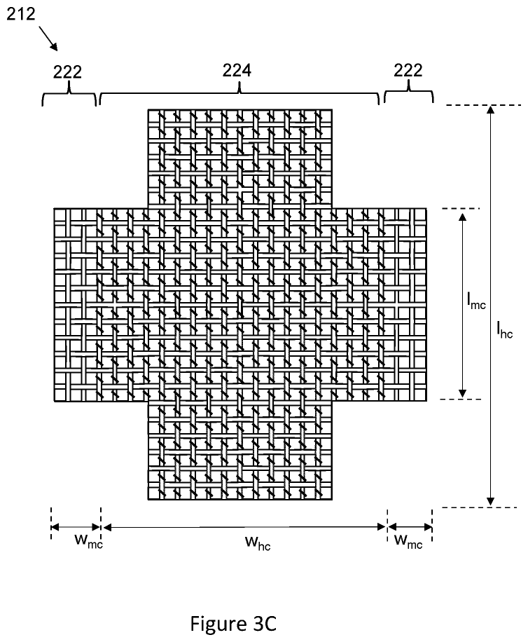

FIG. 3A shows a schematic illustration of the first example of a susceptor assembly according to the present disclosure;

FIG. 3B shows a schematic illustration of a second example of a susceptor assembly according to the present disclosure;

FIG. 3C shows a schematic illustration of a third example of a susceptor assembly according to the present disclosure;

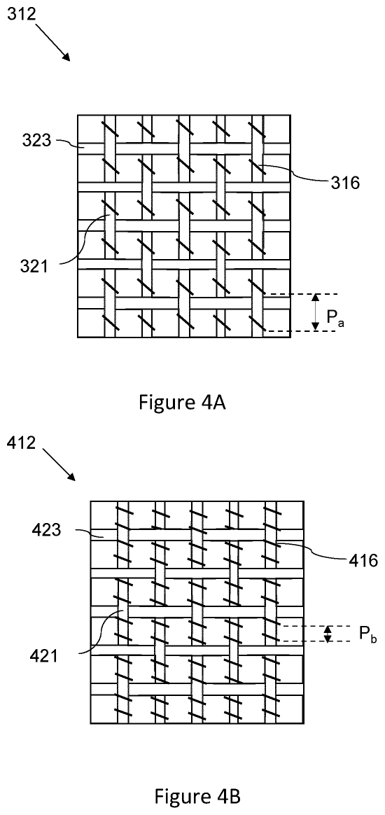

FIG. 4A shows a schematic illustration of a portion of a fourth example of susceptor assembly according to the present disclosure;

FIG. 4B shows a schematic illustration of a portion of a fifth example susceptor assembly according to of the present disclosure;

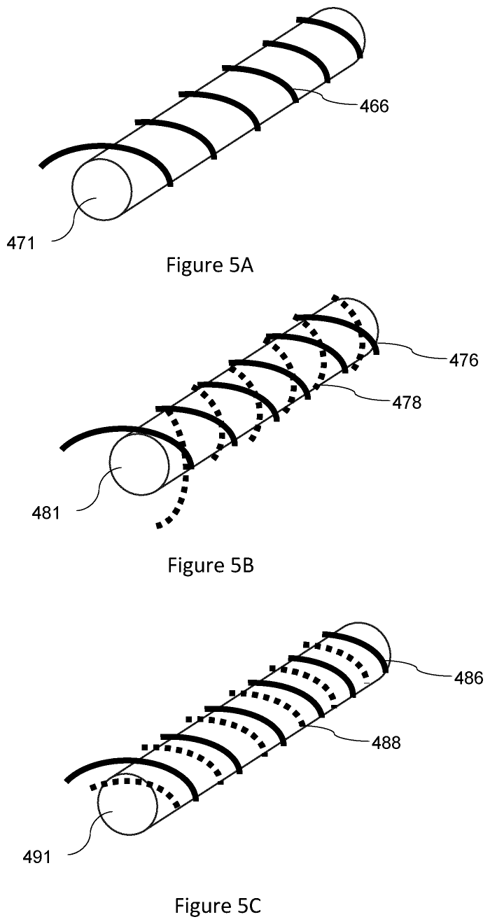

FIGS. 5A-5C show perspective views of exemplary filaments according to the present disclosure;

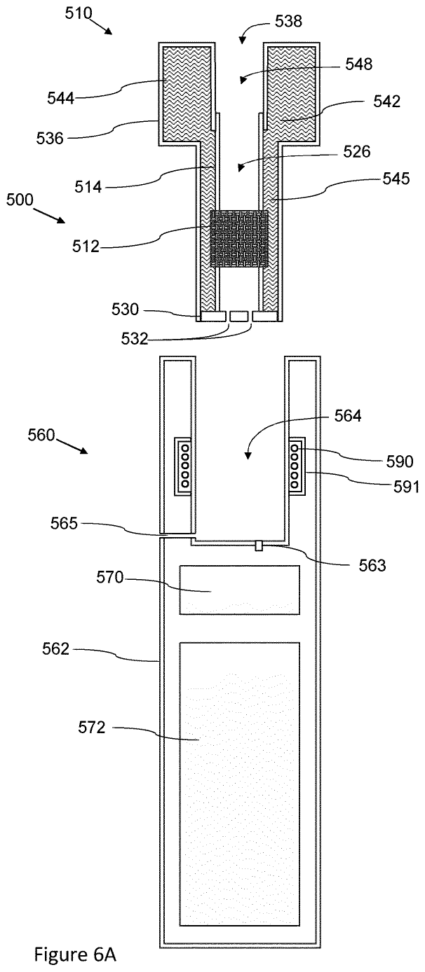

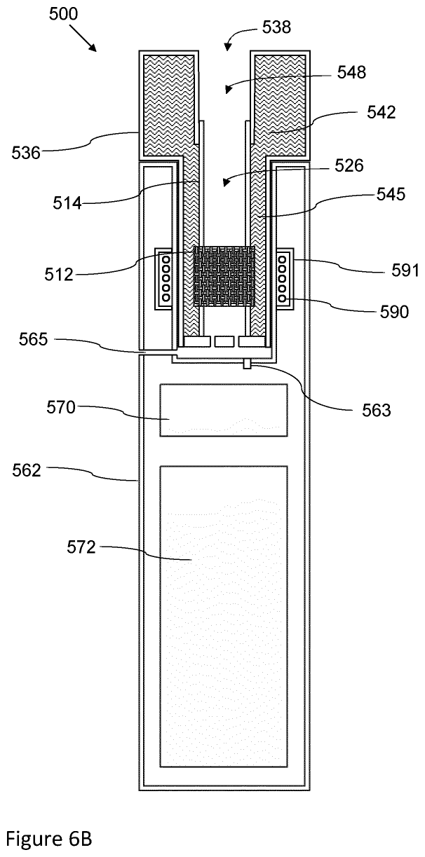

FIG. 6A shows a schematic illustration of a cross-section of a second aerosol-generating system comprising a sixth example of a susceptor assembly according of the present disclosure;

FIG. 6B shows a schematic illustration of a cross-section of the aerosol-generating system of FIG. 6A, in a use configuration;

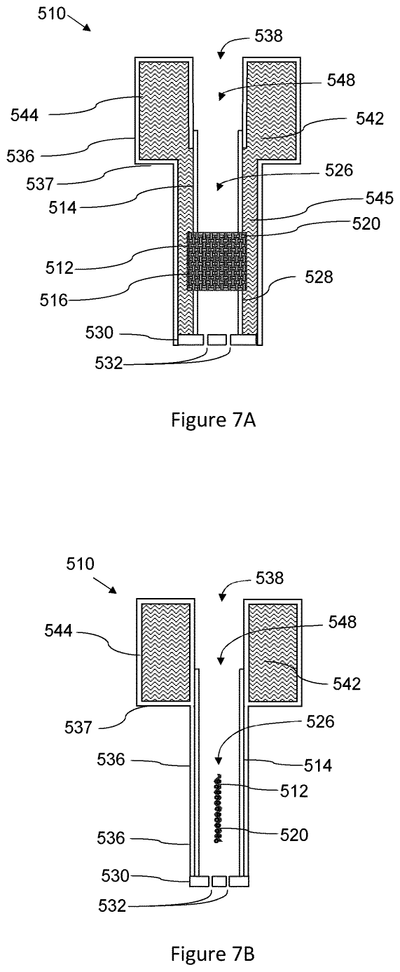

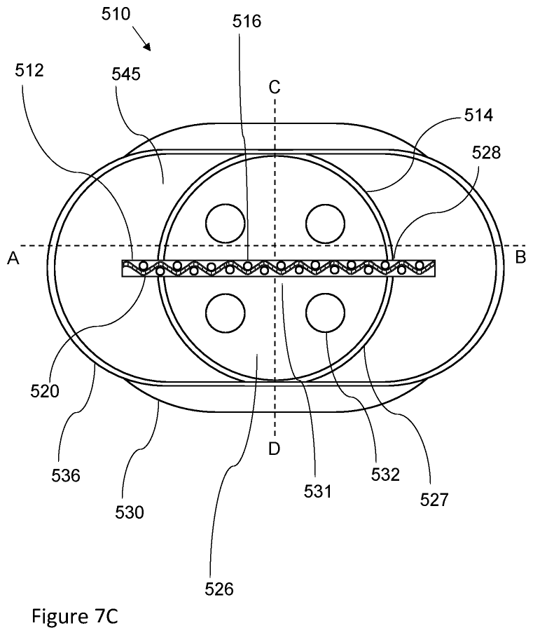

FIG. 7A shows a schematic illustration of a cross-section of a cartridge for the aerosol-generating system of FIG. 6A;

FIG. 7B shows a schematic illustration of an alternative cross-section of the cartridge of FIG. 7A;

FIG. 7C shows a schematic illustration of a further alternative cross-section of the cartridge of FIGS. 7A and 7B;

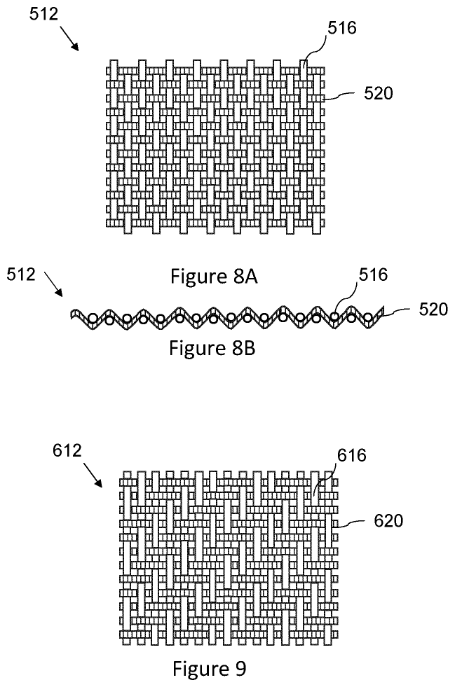

FIG. 8A shows a schematic illustration of the sixth example of a susceptor assembly for the aerosol-generating system of FIG. 6A;

FIG. 8B shows a schematic illustration of a cross-section of the susceptor assembly of FIG. 8A.

FIG. 9 shows a schematic illustration of a seventh example of a susceptor assembly for the aerosol-generating system of FIG. 6A;

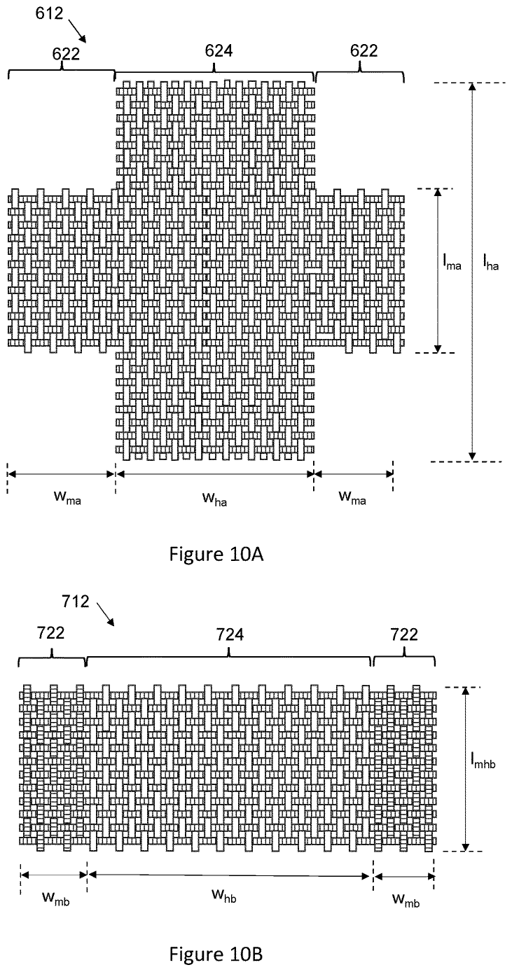

FIG. 10A shows a schematic illustration of an eighth example of a susceptor assembly for the aerosol-generating system of FIG. 6A;

FIG. 10B shows a schematic illustration of a ninth example of a susceptor assembly for the aerosol-generating system of FIG. 6A; and

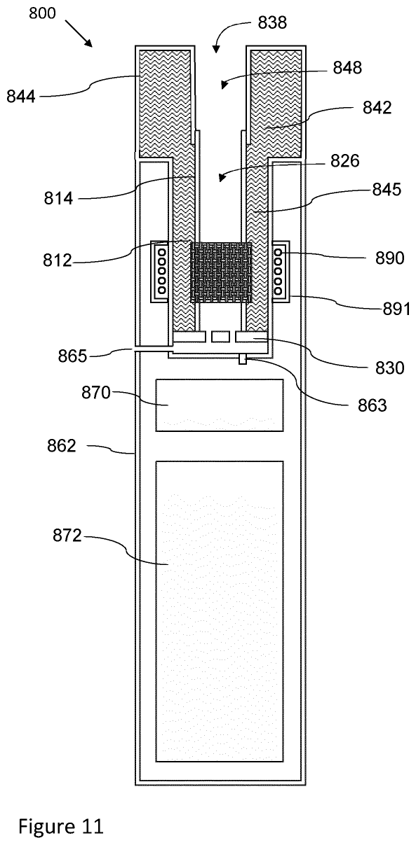

FIG. 11 shows a schematic illustration of a cross-section of a third example of an aerosol-generating system according to the present disclosure.

FIG. 1A shows a schematic illustration of a cross-section of an aerosol-generating system comprising a first example of a susceptor assembly according to the present disclosure. The system 100 comprises a cartridge 10 and a device 60. FIG. 1A shows the system wherein the cartridge 10 is decoupled from the aerosol-generating device 60. The aerosol-generating system is portable and has a size comparable to a conventional cigar or cigarette

The cartridge 10 comprises a susceptor assembly 12 mounted in a susceptor holder 14. The susceptor assembly 12 is shown in more detail in FIGS. 2A, 2B and 2C. The susceptor assembly 12 is planar, and thin, having a thickness dimension that is substantially smaller than a length dimension and a width dimension. The susceptor assembly 12 comprises an array of filaments of a wicking material for conveying liquid aerosol-forming substrate. The array of filaments form a mesh. The susceptor assembly 12 comprises at least one filament of an electrically conductive material heatable by penetration with an alternating magnetic field. The at least one filament of the electrically conductive material is wrapped around and in contact with a first filament of the array of filaments of the wicking material.

The cartridge 10 has a mouth end, and a connection end, opposite the mouth end. An outer housing 36 defines a mouth end opening 38 at the mouth end of the cartridge 10. The connection end is configured for connection of the cartridge 10 to an aerosol-generating device, as described in detail below. The susceptor assembly 12 and the susceptor holder 14 are located towards the connection end of the cartridge 10. The susceptor assembly 12 contacts the susceptor holder 14, such that the susceptor holder 14 supports the susceptor assembly 12 in position in the cartridge 10.

The susceptor holder 14 comprises a tubular body formed from a mouldable plastic material, such as polypropylene. The tubular body of the susceptor holder 14 comprises a side wall defining an internal passage 26, having open ends. A pair of openings 28 extend through the side wall, at opposite sides of the tubular susceptor holder 14. The openings 28 are arranged centrally along the length of the susceptor holder 14. The susceptor holder 14 comprises a base 30 that partially closes one end of the internal passage 26. The base 30 comprises a plurality of air inlets 32 that enable air to be drawn into the internal passage 26 through the partially closed end.

The susceptor assembly 12 is partially arranged inside the internal passage 26 of the susceptor holder 14, and extends in a plane parallel to a central longitudinal axis of the susceptor holder 14. The at least one filament of the electrically conductive material is arranged entirely within the internal passage 26 of the susceptor holder 14 and at least some of the array of filaments of a wicking material that form the mesh extend through openings 28 in the side wall of the susceptor holder 14 into one of two channels 45.

The cartridge 10 further comprises a liquid reservoir 44. The liquid reservoir 44 is defined in the cartridge 10 for holding a liquid aerosol-forming substrate 42. The liquid reservoir 44 extends from the mouth end of the outer housing 36 to the connection end of the outer housing 36, and comprises an annular space defined by the outer housing 36. The annular space has an internal passage 48 that extends between the mouth end opening 38, and the open end of the internal passage 26 of the susceptor holder 14.

The liquid reservoir 44 further comprises two channels 45, the two channels 45 being defined between an inner surface of the outer housing 36 and an outer surface of the susceptor holder 14. The two channels 45 extend from the annular space defined by the outer housing 36 at the mouth end of the cartridge 10, to the connection end of the cartridge 10.

At least some of the array of filaments of a wicking material that form the mesh extend through openings 28 in the side wall of the susceptor holder 14 into one of two channels 45. The two channels 45 extend from the annular space defined by the outer housing 36 at the mouth end of the cartridge 10 on opposite sides of the internal passage 26 of the susceptor holder 14.

An airflow passage is formed through the cartridge 10 by the internal passage 26 of the susceptor holder 14, and the internal passage 48 of the liquid reservoir 44. The air passage extends from the air inlets 32 in the base 30 of the susceptor holder 14, through the internal passage 26 of the susceptor holder 14, and through the internal passage 48 of the liquid reservoir 44 to the mouth end opening 38. The airflow passage enables air to be drawn through the cartridge 10 from the connection end to the mouth end.

The aerosol-generating device 60 comprises a generally cylindrical device outer housing 62 having a connection end and a distal end opposite the connection end. A cavity 64 for receiving a connection end of the cartridge is located at the connection end of the device 60, and an air inlet 65 is provided through the device outer housing 62 at the base of the cavity 64 to enable ambient air to be drawn into the cavity 64.

The device 60 further comprises an inductive heating arrangement arranged within the device outer housing 62. The inductive heating arrangement includes an inductor coil 90, control circuitry 70 and a power supply 72. The power supply 72 comprises a rechargeable lithium ion battery, which is rechargeable via an electrical connector (not shown) at the distal end of the device. The control circuitry 70 is connected to the power supply 72, and to the inductor coil 90, such that the control circuitry 70 controls the supply of power to the inductor coil 90. The control circuitry 70 is configured to supply an alternating current to the inductor coil 90.

The singular inductor coil 90 is positioned around the susceptor assembly 12 when the cartridge 10 is received in the cavity 64. The inductor coil 90 has a size and a shape matching the size and shape of a heating region of the susceptor assembly. The inductor coil 90 is made with a copper wire having a round circular section, and is arranged on a coil former element (not shown). The inductor coil 90 is a helical coil, and has a circular cross-section when viewed parallel to the longitudinal axis of the aerosol-generating device.

The inductor coil 90 is configured such that when the alternating current is supplied to the inductor coil, the inductor coil generates an alternating magnetic field in the region of the susceptor assembly 12 when the cartridge 10 is received in the cavity 64.

The inductive heating arrangement further includes a flux concentrator element 91. The flux concentrator element 91 has a greater radius than the inductor coil 90, and so partially surrounds the inductor coil 90. The flux concentrator element 91 is configured to attenuate the alternating magnetic field outside of the aerosol-generating system. This may reduce interference between the alternating magnetic field and other nearby electronic devices and reduce the risk of the alternating magnetic field inductively heating nearby objects outside of the aerosol-generating system.

FIG. 1B shows a schematic illustration of a cross-section of the aerosol-generating system 100 of FIG. 1A, but wherein the cartridge 10 is coupled to the aerosol-generating device 60, this is the use configuration.

In operation, when a user puffs on the air outlet 38 of the cartridge 10, ambient air is drawn into the base of the cavity 64 through device air inlet 65, and into the cartridge 10 through the air inlets 32 in the base 30 of the cartridge 10. The ambient air flows through the cartridge 10 from the base 30 to the cartridge air outlet, the mouth end opening 38, through the airflow passage, and over the susceptor assembly 12.

The control circuitry 70 controls the supply of electrical power from the power supply 72 to the inductor coil 90 when the system is activated.

The control circuitry 70 includes an airflow sensor 63. The airflow sensor 63 is in fluid communication with the passage of ambient air which is drawn through the system by the user. The control circuitry 72 supplies electrical power to the inductor coil 90 when user puffs on the cartridge 10 are detected by the airflow sensor 63.

When the system is activated, an alternating current is established in the inductor coil 90 which generates alternating magnetic fields in the cavity 64 that penetrate the susceptor assembly 12 in direction parallel to the longitudinal filaments of the susceptor assembly 12, causing the electrically conductive material of the susceptor assembly to heat. Liquid aerosol-forming substrate in the channels 45 is drawn into the susceptor assembly 12 by the mesh of filaments of the wicking material and supplied to the filaments of electrically conductive material. The liquid aerosol-forming substrate 42 at the at the filaments of electrically conductive material is heated, and volatile compounds from the heated aerosol-forming substrate are released into the air passage of the cartridge 10, which cool to form an aerosol. The aerosol is entrained in the air being drawn through the air passage of the cartridge 10, and is drawn out of the cartridge 10 at the air outlet 38 for inhalation by the user.

FIGS. 2A and 2B show a schematic illustrations of two cross-sections of the cartridge 10 according to the first example of a susceptor assembly.

The two cross-sections are taken in two planes perpendicular to one another. The description of the cartridge 10 for FIGS. 1A and 1B may be applied to the cartridge 10 of FIGS. 2A, 2B and 2C. Further details of the cartridge 10 are described with reference to FIGS. 2A-2C below.

The susceptor assembly 12 is shaped in the form of a rectangle, and comprises an array of filaments of a rayon wicking material forming a mesh 20. The mesh 20 comprises a plurality of longitudinal filaments of the wicking material which extend in a substantially longitudinal direction and a plurality of lateral filaments of the wicking material which extend in a substantially lateral direction. The susceptor assembly 12 also comprises filaments of electrically conductive material 16, in this example the electrically conductive material is a ferritic stainless steel. The filaments of electrically conductive material 16 are heatable by penetration with an alternating magnetic field, for vaporising an aerosol-forming substrate. The filaments of electrically conductive material 16 are wrapped around and in contact with filaments of the wicking material that extend in the substantially longitudinal direction. The longitudinal direction is parallel to the direction of air flow across a surface of the susceptor assembly 12 in use.

The mesh 20 comprises two outer portions of mesh, each protruding into one of two channels 45. The mesh 20 is configured to deliver liquid from the outer, exposed surfaces of the mesh 20 to the filaments of electrically conductive material 16. The mesh 20 contacts the susceptor holder 14, such that the susceptor holder 14 supports the susceptor assembly 12 in position in the cartridge 10. The susceptor holder 14 is in physical contact with the wicking material of the mesh 14 but not in physical contact with the filaments of electrically conductive material 16.

The susceptor assembly 12 is partially arranged inside the internal passage 26 of the tubular susceptor holder 14, and extends in a plane parallel to a central longitudinal axis of the susceptor holder 14. The electrically conductive filaments 16 are arranged entirely within the internal passage 26 of the susceptor holder 14. Some of the array of filaments of a wicking material that form the mesh 20 extend through openings 28 in the side wall of the susceptor holder 14 into one of two channels 45.

The external width of the outer housing 36 is greater at the mouth end of the cartridge 10 than at the connection end, which are joined by a shoulder 37. The connection end of the cartridge 10 is received in a cavity of an aerosol-generating device, with the shoulder 37 locating the cartridge in the correct position in the device. The mouth end of the cartridge 10 is outside of the aerosol-generating device, with the mouth end conforming to the external shape of the aerosol-generating device.

FIG. 2C shows a schematic illustration of a further alternative cross-section of the cartridge 10 of FIGS. 2A and 2B. The cartridge 10 is viewed perpendicular to the views shown in FIGS. 2A and 2B, such that the cross-section shown in FIG. 2A is indicated by the dashed line AB, and the cross-section shown in FIG. 2B is indicated by the dashed line CD.

The openings 28 in the side wall of the susceptor holder 14 are sized to accommodate the susceptor assembly 12 with a friction fit, such that the susceptor assembly is secured in the susceptor holder 14. The friction fit between the susceptor assembly 12 and the susceptor holder 14 results in the outer portions of the susceptor assembly directly contacting the susceptor holder 14 at the openings 28. The outer portions of the susceptor assembly comprise a portion of the array of filament of wicking material forming the mesh 20. The outer portions do not comprise any filaments of electrically conductive material 16. An inner portion of the susceptor assembly 12 that is positioned within the internal passage 26 comprises a portion of the array of filament of wicking material forming the mesh 20 and the electrically conductive filaments 16 that are wrapped around, to provide physical contact with filaments of the wicking material. The susceptor assembly 12 and the susceptor holder 14 are secured together such that movement of the susceptor holder 14 also moves the susceptor assembly 12.

The susceptor assembly 12 and the susceptor holder 14 may be secured together by other means. For example, in some embodiments the susceptor assembly 12 is secured to the susceptor holder 14 by an adhesive at the mounting regions 22 of the susceptor assembly 12, such that the mounting regions indirectly contact the susceptor holder 14.

The two channels 45 are positioned on opposite sides of the internal passage 26, and in use the two channels 45 supply liquid aerosol-forming substrate to the susceptor assembly 12. The mesh 20 extends out of the internal passage 26 into both of the channels 45 via the openings 28. The channels 45 are shown empty in FIG. 2C, but can be understood to be filled with liquid aerosol-forming substrate prior to use.

The cartridge 10 is viewed in FIG. 2C from the mouth end to the connection end. The plurality of air inlets 32 in the base 30 can therefore be seen in FIG. 2C.

The cross-section of the susceptor assembly 12 can be more clearly seen in FIG. 2C, with the mesh 20 extending into the two channels 45 of the liquid reservoir.

FIG. 3A shows a schematic illustration of the first example of a susceptor assembly. The susceptor assembly 12 comprises a plurality of longitudinal filaments 21 of the wicking material which extend in a substantially longitudinal direction and a plurality of lateral filaments 23 of the wicking material which extend in a substantially lateral direction. The longitudinal filaments extend perpendicular to the lateral filaments. The plurality of longitudinal filaments 21 and lateral filaments 23 are woven to form a woven mesh of filaments 20. Both the lateral filaments and longitudinal filaments are non-electrically conductive filaments comprising rayon.

A plurality of filaments of electrically conductive material 16 are wrapped around longitudinal filaments 21 of the wicking material. As shown in FIG. 3A, one filament of electrically conductive material is wrapped around one longitudinal filament of wicking material 21. Each of the electrically conductive filaments form a helical coil around and in contact with a longitudinal filament 21 of the wicking material. The pitch of the coil is between 10 micrometres and 500 micrometres. A diameter of at least one filament of the electrically conductive material is between 5 micrometres and 100 micrometres. The filaments of electrically conductive material are filaments of ferritic stainless-steel 430.

The diameter of the filaments of the wicking material are between 5 micrometres and 100 micrometres. The filaments of the wicking material define interstices between the filaments and the interstices have a width of between 10 micrometres and 100 micrometres. The filaments of the wicking material give rise to capillary action in the interstices, so that in use, the aerosol-forming liquid is drawn into the interstices, increasing the contact area between the susceptor assembly and the liquid.

The susceptor assembly comprises a pair of mounting regions 22 and a heating region 24. The susceptor assembly 12 is substantially rectangular. The heating region 24 is a substantially rectangular region located centrally on the susceptor assembly. The pair of mounting regions 22 are also substantially rectangular regions located at the periphery of the heating region 24, at opposite sides of the heating region 24. In this embodiment, the mounting regions 22 are arranged at the same central position along the length of the heating region 24.

Each of the pair of mounting regions 22 has a smaller surface area than the heating region 24. The width Wma of each of the mounting regions 22 is less than the width Wht of the heating region 24. In this embodiment, the heating region 24 and the mounting regions have a length Imha of about 6.50 millimetres. The heating region has a width Wha of about 3.50 millimetres. The mounting regions have a width of about 1.15 millimetres. As such, the susceptor assembly 12 has a total length of about 6.50 millimetres, and a total width of about 5.80 millimetres.

The heating region 24 is configured to be heatable by penetration with an alternating magnetic field, for vapourising an aerosol-forming substrate. The pair of mounting regions 22 are configured to contact a susceptor holder, such that the susceptor holder can support the susceptor assembly 12 in position in an aerosol-generating system, for example in a cartridge. The pair of mounting regions 22 are configured to minimise heat transfer from the susceptor assembly to the susceptor holder.

The heating region 24 comprises a portion of the mesh 20 and filaments of electrically conductive material 16. The outer mounting regions 22 comprise portions of the mesh 20, including longitudinal filaments 21 of the wicking material and lateral filament 23 filaments 21 of the wicking material, but do not contain any filaments of electrically conductive material 16. The mounting regions 22 are therefore configured to transport liquid aerosol forming substrate. The outer mounting regions are configured not to heat due to application of an alternating magnetic field. Due to the inclusion of the filaments of electrically conductive material 16, the heating region 24 is configured to be heatable by penetration with an alternating magnetic field.

Providing the susceptor assembly 12 with mounting regions 22 having a reduced cross-section compared to the heating region 24, and comprising the mounting regions 22 from a non-magnetic material helps to reduce heating of the mounting regions 22 when the susceptor assembly is penetrated by an alternating magnetic field. Such a configuration also helps to reduce heat transfer from the susceptor assembly 12 to the susceptor holder.

The susceptor assembly of the first embodiment of the present disclosure can be manufactured according to the following method. The method comprises providing the plurality of filaments of the wicking material for conveying liquid aerosol-forming substrate. A portion of the plurality of filaments of the wicking material may be selected to be wrapped in filaments of an electrically conductive material. For example, a third of the plurality of filaments may be selected.

The method further comprises wrapping a filament of an electrically conductive material heatable by penetration with an alternating magnetic field around each filament of the plurality of filaments of the wicking material selected for this purpose. For example, a filament electrically conductive material is wrapped around a filament of the wicking material. This is done to the selected number of filaments of the wicking material, for example a third of the total number of filaments of the wicking material.

The method further comprises assembling the plurality of filaments of the wicking material to form a mesh. The mesh is assembled by providing a plurality of filaments of the wicking material in a lateral direction. A plurality of filaments of the wicking material in the longitudinal direction are woven with these filaments.

FIG. 3B shows a schematic illustration of a second example of a susceptor assembly according to the present disclosure. In this example, the susceptor assembly 112 is shaped in the form of a cross. The susceptor assembly 112 is substantially the same as the susceptor assembly of FIG. 3A, except that it has a different geometry and positioning of the electrically conductive filaments, as described below.

The susceptor assembly 112 comprises a pair of mounting regions 122 and a heating region 124. The susceptor assembly 112 is substantially planar with a cross-shape cross-section. The heating region 124 is a substantially rectangular region located centrally on the susceptor assembly. The pair of mounting regions 122 are also substantially rectangular regions located at the periphery of the heating region 124, at opposite sides of the heating region 124. In this embodiment, the mounting regions 122 are arranged at the same central position along the length of the heating region 124.

Each of the pair of mounting regions 122 has a smaller surface area than the heating region 124. The width w_{mb} of each of the mounting regions 122 is less than the width w_{hb} of the heating region 124. In this embodiment, the heating region 124 has a total length l_{hb} of about 8.8 millimetres, and a width w_{hb} of about 3.50 millimetres. Each of the mounting regions 122 have a length l_{mb} of about 6.50 millimetres, and a width w_{mb} of about 1.15 millimetres. As such, the susceptor assembly 112 has a total maximum length of about 8.80 millimetres, and a total maximum width of about 5.80 millimetres.

The heating region 124 is configured to be heatable by penetration with an alternating magnetic field, for vapourising an aerosol-forming substrate. The pair of mounting regions 122 are configured to contact a susceptor holder, such that the susceptor holder can support the susceptor assembly 112 in position in an aerosol-generating system, for example in a cartridge. The pair of mounting regions 122 are configured to minimise heat transfer from the susceptor assembly to the susceptor holder.

Providing the susceptor assembly 112 with mounting regions 122 having a reduced cross-section compared to the heating region 124, and comprising the mounting regions 122 from a non-magnetic material helps to reduce heating of the mounting regions 122 when the susceptor assembly is penetrated by an alternating magnetic field. Such a configuration also helps to reduce heat transfer from the susceptor assembly 112 to the susceptor holder.

FIG. 3C shows a schematic illustration of a third example of a susceptor assembly according to the present disclosure. In this example, the susceptor assembly 212 is shaped in the form of a cross. The susceptor assembly 212 is substantially the same as the susceptor assembly of FIG. 3B, except that it has different positioning of the electrically conductive filaments, as described below.

The susceptor assembly 212 comprises a pair of mounting regions 222 and a heating region 224. The susceptor assembly 212 is substantially planar with a cross-shape cross-section. The heating region 224 is a shaped in the form of a cross and located centrally on the susceptor assembly. The pair of mounting regions 222 are also substantially rectangular regions located at the periphery of the heating region 224, at opposite sides of the heating region 224. In this embodiment, the mounting regions 122 are arranged at the same central position along the length of the heating region 124.

Each of the pair of mounting regions 122 has a smaller surface area than the heating region 124. The width w_{mc} of each of the mounting regions 122 is less than the width w_{hc} of the heating region 124. In this embodiment, the heating region 124 has a total length l_{hc} of about 8.8 millimetres, and a width w_{hc} of about 4.75 millimetres. Each of the mounting regions 122 have a length l_{mc} of about 6.50 millimetres, and a width w_{mc} of about 0.5 millimetres. As such, the susceptor assembly 112 has a total maximum length of about 8.80 millimetres, and a total maximum width of about 5.80 millimetres.

FIG. 4A shows a schematic illustration of a portion of a fourth example of susceptor assembly according to the present disclosure.

The portion of the susceptor assembly 312 comprises a plurality of longitudinal filaments 321 of the wicking material which extend in a substantially longitudinal direction and a plurality of lateral filaments 323 of the wicking material which extend in a substantially lateral direction. The longitudinal filaments extend perpendicular to the lateral filaments. The plurality of longitudinal filaments 321 and lateral filaments 323 are woven to form a woven mesh of filaments 320. Both the lateral filaments and longitudinal filaments are non-electrically conductive filaments comprising rayon.

A plurality of filaments of electrically conductive material 316 are wrapped around longitudinal filaments 321 of the wicking material. One filament of electrically conductive material is wrapped around one longitudinal filament of wicking material 321 for conveying liquid aerosol-forming substrate. Each of the electrically conductive filaments form a helical coil around and in contact with a longitudinal filament 321 of the wicking material. A pitch Pa of the coil is around 200 micrometres and is regular along a length of the coil. Each coil of the electrically conductive material has the same pitch Pa along the length of the coil. The diameter of at least one filament of the electrically conductive material is between 5 micrometres and 100 micrometres. The filaments of electrically conductive material are filaments of ferritic stainless-steel 430.

The diameter of the filaments of the wicking material are between 5 micrometres and 100 micrometres. The filaments of the wicking material define interstices between the filaments and the interstices may have a width of between 10 micrometres and 100 micrometres. The filaments of the wicking material give rise to capillary action in the interstices, so that in use, the aerosol-forming liquid is drawn into the interstices, increasing the contact area between the susceptor assembly and the liquid.

FIG. 4A shows a schematic illustration of a portion of a fifth example of susceptor assembly according to the present disclosure. The portion of the susceptor assembly of FIG. 4B is the same as that of 4A, except where described below.

The portion of the susceptor assembly 412 comprises a plurality of longitudinal filaments 421 of the wicking material which extend in a substantially longitudinal direction and a plurality of lateral filaments 423 of the wicking material which extend in a substantially lateral direction. The electrically conductive filament 416 is wrapped around and in contact with the longitudinal filaments of the wicking material 421. The electrically conductive filaments form a helical coil. The helical coil has a pitch Pb. The pitch Pb of the coil is around 200 micrometres and is regular along a length of the coil.

FIGS. 5A, 5B and 5C show perspective views of exemplary filaments according to the present disclosure.

FIG. 5A shows a filament 471 of a wicking material. A filament of an electrically conductive material 466 is wrapped around and in contact with the filament of the wicking material 471. The filament of the electrically conductive material 466 forms a helical coil around the filament of wicking material 471.

FIG. 5B shows a filament of a wicking material 481 with two filaments of electrically conductive material 476, 478 wrapped around and in contact with the filament of the wicking material 481. The two filaments of electrically conductive material 476, 478 are wrapped around the filament of wicking material 481 so that the two filaments 476, 478 overlap. For example, during manufacture a first filament 476 is wrapped about the filament of wicking material 481, and then a second filament 478 is wrapped around the filament of wicking material 481 in an opposite direction to the wrapping direction of the first filament 476. In this way, the two filaments of electrically conductive material 476, 478 are in contact with each other. The overlapping filaments can cause hot spots during use when an alternating magnetic field is applied to the susceptor assembly.

FIG. 5C shows a filament of a wicking material 491 with two filaments of electrically conductive material 486, 488 wrapped around and in contact with the filament of the wicking material 491. The first filament of electrically conductive material 486 is not in contact with the second filament of the electrically conductive material 488. Both filaments of electrically conductive material 486, 488 are wrapped around the filament of wicking material 491 in the same direction so that there two filaments do not overlap. For example, during manufacture a first filament 486 is wrapped about the filament of wicking material 491, and then a second filament 488 is wrapped around the filament of wicking material 491 in an opposite the same direction as the wrapping direction of the first filament8. In this way, the two filaments of electrically conductive material 486, 488 are not in contact with each other this can prevent hotspots occurring in the susceptor assembly. No contact between the two filaments of electrically conductive material 486, 488 can lead to even heat distribution along the length of the filament of wicking material 491.

FIG. 6A shows a schematic illustration of a cross-section of a second aerosol-generating system comprising a sixth example of a susceptor assembly according of the present disclosure. The system 500 comprises a cartridge 510 and a device 560. FIG. 6A shows the system wherein the cartridge 510 is decoupled from the aerosol-generating device 650. The aerosol-generating system is portable and has a size comparable to a conventional cigar or cigarette.

The cartridge 510 comprises a susceptor assembly 512 mounted in a susceptor holder 514. The susceptor assembly 512 is shown in more detail in FIGS. 7A to 8B. The susceptor assembly 512 is planar, and thin, having a thickness dimension that is substantially smaller than a length dimension and a width dimension. The susceptor assembly 512 comprises a mesh. The mesh comprises a plurality of filaments of an electrically conductive material heatable by penetration with an alternating magnetic field. The plurality of filaments of the electrically conductive material extend in a first direction. The mesh also comprises a plurality of filaments a wicking material, for conveying liquid from the liquid reservoir to the susceptor assembly. The plurality of filaments of the wicking material extend in a second direction. The first direction is perpendicular to the second direction. The first direction is parallel to the direction or air flow across a surface of the susceptor assembly 512 in use.

The cartridge 510 has a mouth end, and a connection end, opposite the mouth end. An outer housing 536 defines a mouth end opening 538 at the mouth end of the cartridge 510. The connection end is configured for connection of the cartridge 10 to an aerosol-generating device, as described in detail below. The susceptor assembly 512 and the susceptor holder 14 are located towards the connection end of the cartridge 510. The susceptor assembly 512 contacts the susceptor holder 514, such that the susceptor holder 514 supports the susceptor assembly 512 in position in the cartridge 510.

The susceptor holder 514 comprises a tubular body formed from a mouldable plastic material, such as polypropylene. The outer housing 536 defines an internal space in which the susceptor assembly 512 and the susceptor holder 514 are contained.

The external width of the outer housing 536 is greater at the mouth end of the cartridge 510 than at the connection end, which are joined by a shoulder 537. This enables the connection end of the cartridge 510 to be received in a cavity of an aerosol-generating device, with the shoulder 537 locating the cartridge in the correct position in the device. This also enables the mouth end of the cartridge 510 to remain outside of the aerosol-generating device, with the mouth end conforming to the external shape of the aerosol-generating device.

The tubular body of the susceptor holder 514 comprises a side wall defining an internal passage 526, having open ends. A pair of openings 528 extend through the side wall, at opposite sides of the tubular susceptor holder 514. The openings 528 are arranged centrally along the length of the susceptor holder 514. The susceptor holder 514 comprises a base 530 that partially closes one end of the internal passage 526. The base 530 comprises a plurality of air inlets 532 that enable air to be drawn into the internal passage 526 through the partially closed end.

The susceptor assembly 512 is partially arranged inside the internal passage 526 of the susceptor holder 514, and extends in a plane parallel to a central longitudinal axis of the susceptor holder 514. A portion of the susceptor assembly 520 extends out through openings 528 in the side wall of the susceptor holder 514 into one of two channels 545.

The cartridge 510 further comprises a liquid reservoir 544. The liquid reservoir 544 is defined in the cartridge 510 for holding a liquid aerosol-forming substrate 542. The liquid reservoir 544 extends from the mouth end of the outer housing 536 to the connection end of the outer housing 536, and comprises an annular space defined by the outer housing 536. The annular space has an internal passage 548 that extends between the mouth end opening 538, and the open end of the internal passage 526 of the susceptor holder 514.

The liquid reservoir 544 further comprises two channels 545, the two channels 545 being defined between an inner surface of the outer housing 36 and an outer surface of the susceptor holder 514. The two channels 545 extend from the annular space defined by the outer housing 536 at the mouth end of the cartridge 510, to the connection end of the cartridge 510, such that the susceptor assembly 512 extends through openings 528 in the side wall of the susceptor holder 514 into one of two channels 545. The two channels 45 extend from the annular space defined by the outer housing 536 at the mouth end of the cartridge 510 on opposite sides of the internal passage 526 of the susceptor holder 514.

An air passage is formed through the cartridge 510 by the internal passage 526 of the susceptor holder 514, and the internal passage 548 of the liquid reservoir 544. The air passage extends from the air inlets 532 in the base 530 of the susceptor holder 514, through the internal passage 526 of the susceptor holder 514, and through the internal passage 548 of the liquid reservoir 544 to the mouth end opening 538. The air passage enables air to be drawn through the cartridge 510 from the connection end to the mouth end.

The aerosol-generating device 560 comprises a generally cylindrical device outer housing 562 having a connection end and a distal end opposite the connection end. A cavity 564 for receiving a connection end of the cartridge is located at the connection end of the device 560, and an air inlet 565 is provided through the device outer housing 562 at the base of the cavity 564 to enable ambient air to be drawn into the cavity 564.

The device 560 further comprises an inductive heating arrangement arranged within the device outer housing 562. The inductive heating arrangement includes an inductor coil 590, control circuitry 570 and a power supply 572. In use, the inductor coil 590 is arranged around the susceptor assembly 512 to generate an alternating magnetic field for penetrating the susceptor assembly 512 in a direction substantially parallel to the first direction. The power supply 572 comprises a rechargeable lithium ion battery, which is rechargeable via an electrical connector (not shown) at the distal end of the device. The control circuitry 570 is connected to the power supply 572, and to the inductor coil 590, such that the control circuitry 570 controls the supply of power to the inductor coil 590. The control circuitry 570 is configured to supply an alternating current to the inductor coil 590.

The singular inductor coil 590 is positioned around the susceptor assembly 512 when the cartridge 510 is received in the cavity 564. The inductor coil 590 has a size and a shape matching the size and shape of a heating region of the susceptor assembly. The inductor coil 590 is made with a copper wire having a round circular section, and is arranged on a coil former element (not shown). The inductor coil 590 is a helical coil, and has a circular cross-section when viewed parallel to the longitudinal axis of the aerosol-generating device.

The inductor coil 590 is configured such that when the alternating current is supplied to the inductor coil, the inductor coil generates an alternating magnetic field in the region of the susceptor assembly 512 when the cartridge 510 is received in the cavity 564.

The inductive heating arrangement further includes a flux concentrator element 591. The flux concentrator element 591 has a greater radius than the inductor coil 590, and so partially surrounds the inductor coil 590. The flux concentrator element 591 is configured to attenuate the alternating magnetic field outside of the aerosol-generating system. This may reduce interference between the alternating magnetic field and other nearby electronic devices and reduce the risk of the alternating magnetic field inductively heating nearby objects outside of the aerosol-generating system.

FIG. 6B shows a schematic illustration of a cross-section of the aerosol-generating system 500 of FIG. 6A, but wherein the cartridge 510 is coupled to the aerosol-generating device 560, this is the use configuration.

In operation, when a user puffs on the air outlet 538 of the cartridge 510, ambient air is drawn into the base of the cavity 64 through device air inlet 565, and into the cartridge 510 through the air inlets 532 in the base 530 of the cartridge 510. The ambient air flows through the cartridge 510 from the base 530 to the cartridge air outlet, the mouth end opening 538, through the airflow passage, and over the susceptor assembly 512.

The control circuitry 570 controls the supply of electrical power from the power supply 572 to the inductor coil 590 when the system is activated.

The control circuitry 570 includes an airflow sensor 563. The airflow sensor 563 is in fluid communication with the passage of ambient air which is drawn through the system by the user. The control circuitry 572 supplies electrical power to the inductor coil 590 when user puffs on the cartridge 510 are detected by the airflow sensor 563.

When the system is activated, an alternating current is established in the inductor coil 90 which generates alternating magnetic fields in the cavity 564 that penetrate the susceptor assembly 512, causing the electrically conductive material of the susceptor assembly to heat. Liquid aerosol-forming substrate in the channels 545 is drawn into the susceptor assembly 512 by the mesh of filaments of the wicking material and supplied to the filaments of electrically conductive material. The liquid aerosol-forming substrate 542 at the filaments of electrically conductive material is heated, and volatile compounds from the heated aerosol-forming substrate are released into the air passage of the cartridge 510, which cool to form an aerosol. The aerosol is entrained in the air being drawn through the air passage of the cartridge 510, and is drawn out of the cartridge 510 at the air outlet 538 for inhalation by the user.

FIGS. 7A and 7B show a schematic illustrations of two cross-sections of a cartridge for the aerosol-generating system of FIG. 6A. The two cross-sections are taken in two planes perpendicular to one another. The description of the cartridge 510 of FIGS. 6A and 6B may be applied to the cartridge 510 of FIGS. 7A, 7B and 7C. Further details of the cartridge 510 are described with reference to FIGS. 7A-7C below.

The susceptor assembly 512 is shaped in the form of a rectangle, and comprises a mesh. The mesh comprises a plurality of filaments of an electrically conductive material 516 heatable by penetration with an alternating magnetic field. The plurality of filaments of the electrically conductive material extend in a first direction. The mesh also comprises a plurality of filaments a wicking material 520, for conveying liquid from a liquid reservoir to the susceptor assembly 512. The plurality of filaments of the wicking material 520 extend in a second direction. The first direction is perpendicular to the second direction. The first direction is parallel to the direction of air flow across a surface of the susceptor assembly 512 in use.

The susceptor assembly 512 comprises two outer portions of mesh, each protruding into one of two channels 545. The mesh is configured to deliver liquid from the outer, exposed surfaces of the mesh to the filaments of electrically conductive material 516. The mesh contacts the susceptor holder 514, such that the susceptor holder 514 supports the susceptor assembly 512 in position in the cartridge 510. The susceptor holder 514 is in physical contact with the wicking material of the mesh 514 but not in physical contact with the filaments of electrically conductive material 516.

The external width of the outer housing 536 is greater at the mouth end of the cartridge 510 than at the connection end, which are joined by a shoulder 537. This enables the connection end of the cartridge 510 to be received in a cavity of an aerosol-generating device, with the shoulder 537 locating the cartridge in the correct position in the device. This also enables the mouth end of the cartridge 510 to remain outside of the aerosol-generating device, with the mouth end conforming to the external shape of an aerosol-generating device.

FIG. 7C shows a schematic illustration of a further alternative cross-section of the cartridge 510 of FIGS. 7A and 7B. The cartridge 510 is viewed perpendicular to the views shown in FIGS. 7A and 7B, such that the cross-section shown in FIG. 7A is indicated by the dashed line AB, and the cross-section shown in FIG. 7B is indicated by the dashed line CD.

The cartridge 510 is viewed in FIG. 7C from the mouth end to the connection end. The plurality of air inlets 532 in the base 530 can therefore be seen in FIG. 7C.

The openings 528 in the side wall of the susceptor holder 514 are sized to accommodate the susceptor assembly 512 with a friction fit, such that the susceptor assembly is secured in the susceptor holder 514. The friction fit between the susceptor assembly 512 and the susceptor holder 514 results in the outer portions of the susceptor assembly directly contacting the susceptor holder 514 at the openings 528. The susceptor assembly 512 and the susceptor holder 514 are secured together such that movement of the susceptor holder 514 also moves the susceptor assembly 512.

The susceptor assembly 512 and the susceptor holder 514 may be secured together by other means. For example, in some embodiments the susceptor assembly 512 is secured to the susceptor holder 514 by an adhesive at the mounting regions 522 of the susceptor assembly 512, such that the mounting regions indirectly contact the susceptor holder 514.

The two channels 545 are positioned on opposite sides of the internal passage 526, and in use the two channels 545 supply liquid aerosol-forming substrate to the susceptor assembly 512. The susceptor assembly 512 extends out of the internal passage 526 into both of the channels 545 via the openings 528. The channels 545 are shown empty in FIG. 7C, but can be understood to be filled with liquid aerosol-forming substrate prior to use.

FIG. 8A shows a schematic illustration of the sixth example of a susceptor assembly for the aerosol-generating system of FIG. 6A.

The susceptor assembly 512 comprises a mesh. The mesh comprises a plurality of filaments of an electrically conductive material 516 heatable by penetration with an alternating magnetic field. The plurality of filaments of the electrically conductive material 516 extend in a first direction. The mesh also comprises a plurality of filaments a wicking material 520, for conveying liquid from the liquid reservoir to the susceptor assembly 512. The plurality of filaments of the wicking material 520 extend in a second direction. The first direction is perpendicular to the second direction.

As shown in FIG. 8A, a first filament of electrically conductive material 516 extending in the first direction is woven across a plurality of rows of filaments of the wicking material 520 extending in the second direction. The first filament of the electrically conductive material 516 is woven over a first filament of the wicking material 520 and then under a second filament of the wicking material 520. This pattern is repeated along a length of the first filament of the electrically conductive material 516. A second filament of electrically conductive material 516 extending in the first direction is woven across a plurality of rows of filaments of the wicking material 520 extending in the second direction. The second filament of the electrically conductive material 516 is woven under a first filament of the wicking material 520 and then over a second filament of the wicking material 520. This pattern is repeated along a length of the second filament of the electrically conductive material 516. Each of the subsequent filaments of the electrically conductive material 516 are woven under and over the plurality of rows of filaments of the wicking material 520 extending in the second direction. The woven filaments of the electrically conductive 516 material and the wicking material 520 form a mesh. The mesh comprises interstices in between the filaments. The interstices have a width of between 10 micrometres and 100 micrometres. The filaments of the wicking material give rise to capillary action in the interstices, so that in use, the aerosol-forming liquid is drawn into the interstices, increasing the contact area between the susceptor assembly and the liquid aerosol-forming substrate.

A diameter of at least one filament of the electrically conductive material 516 is between 5 micrometres and 100 micrometres. The filaments of electrically conductive material 516 are filaments of ferritic stainless-steel 430. The filaments of wicking material 520 comprise rayon.

In use, an inductor coil is arranged around the susceptor assembly 512 and generates an alternating magnetic field for penetrating the susceptor assembly 512 in a direction parallel to the first direction. The filaments of electrically conductive material 516 that extend in the first direction are inductively heated leading to a rise in temperature of the susceptor assembly 512 as a whole. Liquid aerosol-forming substrate that has been wicked into the susceptor assembly 512 is vapourised.

FIG. 8B Shows a schematic cross-sectional view of the portion of the susceptor assembly of FIG. 8A.

The susceptor assembly 512 comprises a woven mesh of filaments. The woven filaments of the first material 516 extend in a first direction. The first direction is parallel to the direction of an alternating magnetic field. The woven filaments of the second material 520 extend in a second direction, substantially perpendicular to the first direction.

The susceptor assembly 512 is a planar assembly. The second filaments 520 extending in the second direction are woven with the first filaments 516 extending in the first direction such that the second filaments 520 extending in the second direction extend further outwards from the plane of the woven mesh of the susceptor assembly 512 than the first filaments extending in the first direction. In other words, the second filaments 520 extending in the second direction define the maximum thickness of the woven mesh.

As the second filaments 520 extending in the second direction define the maximum thickness of the woven mesh of the susceptor assembly 512, a susceptor holder in contact with the susceptor assembly only comes into contact with the second filaments 520 extending in the second direction.

Since the second filaments 520 extending in the second direction are comprised of a wicking material, for example rayon that is not electrically conductive, the second filaments 520 extending in the second direction are not directly heated by the induction of eddy currents, or hysteresis losses when the susceptor assembly is exposed to an alternating magnetic field. As a result, the second filaments 520 extending in the second direction in contact with a susceptor holder transfer less heat to the susceptor holder than if the filaments were comprised of an electrically conductive material.

FIG. 9 shows a schematic illustration of a seventh example of a susceptor assembly for the aerosol-generating system of FIG. 6A.

The susceptor assembly 612 comprises a mesh. The mesh comprises a plurality of filaments of an electrically conductive material 616 heatable by penetration with an alternating magnetic field. The plurality of filaments of the electrically conductive material 616 extend in a first direction. The mesh also comprises a plurality of filaments a wicking material 620, for conveying liquid from the liquid reservoir to the susceptor assembly 612. The plurality of filaments of the wicking material 620 extend in a second direction. The first direction is perpendicular to the second direction. When in use, the susceptor assembly 612 is placed in an alternating magnetic field which penetrates the susceptor assembly 616 in the first direction.

As shown in FIG. 9, a first filament of electrically conductive material 616 extending in the first direction is woven across a plurality of rows of filaments of the wicking material 620 extending in the second direction. The first filament of the electrically conductive material 616 is woven over a first filament of the wicking material 620, over a second filament of the wicking material 620, under a third filament of the wicking material and under a fourth filament of the wicking material 620. This pattern is repeated along a length of the first filament of the electrically conductive material 616. The second filament of the electrically conductive material 516 is woven under a first filament of the wicking material 520 and then over a second filament of the wicking material 520. This pattern is repeated along a length of the second filament of the electrically conductive material 516. The woven filaments of the electrically conductive 516 material and the wicking material 520 form a mesh. The mesh comprises interstices in between the filaments. The interstices have a width of between 10 micrometres and 100 micrometres. The filaments of the wicking material give rise to capillary action in the interstices, so that in use, the aerosol-forming liquid is drawn into the interstices, increasing the contact area between the susceptor assembly and the liquid aerosol-forming substrate.

A diameter of at least one filament of the electrically conductive material 516 is between 5 micrometres and 100 micrometres. The filaments of electrically conductive material 516 are filaments of ferritic stainless-steel 430. The filaments of wicking material 520 comprise rayon.

FIG. 10A shows a schematic illustration of an eighth example of a susceptor assembly for the aerosol-generating system of FIG. 6A.

The susceptor assembly comprises a pair of mounting regions 622 and a heating region 624. The susceptor assembly 612 is shaped in the form of a cross. The heating region 624 is a substantially rectangular regions located centrally on the susceptor assembly 612. The pair of mounting regions 622 are also substantially rectangular regions located at the periphery of the heating region 624, at opposite sides of the heating region 624. In this embodiment, the mounting regions 622 are arranged at the same central position along the length of the heating region 624.

Each of the pair of mounting regions 622 has a smaller surface area than the heating region 624. The width wₘₐ of each of the mounting regions 622 is less than the width wₕₐ of the heating region 624. In this embodiment, the heating region 624 has a total length lₕₐ of about 8.8 millimetres, and a width wₕₐ of about 3.50 millimetres. Each of the mounting regions 622 have a length lₘₐ of about 6.50 millimetres, and a width wₘₐ of about 1.15 millimetres. As such, the susceptor assembly 612 has a total maximum length of about 8.80 millimetres, and a total maximum width of about 5.80 millimetres.

The heating region 624 is configured to be heatable by penetration with an alternating magnetic field, for vapourising an aerosol-forming substrate. The pair of mounting regions 622 are configured to contact a susceptor holder, such that the susceptor holder can support the susceptor assembly 612 in position in an aerosol-generating system, for example in a cartridge. The pair of mounting regions 622 are configured to minimise heat transfer from the susceptor assembly to the susceptor holder.

The heating region 624 comprises a portion of the woven mesh of the susceptor assembly 612. The heating region comprises filaments of a first, electrically conductive material extending in a first direction and filaments of a second, wicking material, extending in a second direction. The first direction is substantially parallel to an alternating magnetic field generated by an inductor coil that surrounds the susceptor assembly (not shown in FIG. 10A). The filaments of the first, magnetic, material are inductively heated by the alternating magnetic field. There are more and longer filaments of the first material in the heating region in comparison to the two mounting regions 622.

The outer mounting regions 622 comprise portions the woven mesh of the susceptor assembly. The woven mesh, comprising the wicking material and interstices defined between the filaments, transports by capillary action liquid aerosol-forming substrate from a liquid reservoir to the susceptor assembly, and across the susceptor assembly 612.

The susceptor assembly 612 is planar, extending substantially in a plane. The second filaments 620 extending in the second direction are woven with the first filaments 616 extending in the first direction such that the second filaments 620 extending in the second direction extend further outwards from the plane of the woven mesh of the susceptor assembly 612 than the first filaments extending in the first direction. In other words, the second filaments 620 extending in the second direction define the maximum thickness of the woven mesh.

As the second filaments 620 extending in the second direction define the maximum thickness of the woven mesh of the susceptor assembly 612, a susceptor holder in contact with the susceptor assembly 612 only comes into contact with the second filaments 620 extending in the second direction. The second filaments 620 do not comprise an electrically conductive material. They are not directly heated by the induction of eddy currents or hysteresis losses when the susceptor assembly 612 is exposed to an alternating magnetic field.

Providing the susceptor assembly 612 with mounting regions 622 having a reduced cross-section compared to the heating region 624, and having only the second filaments in contact with the susceptor holder, helps to reduce heating of the mounting regions 622 when the susceptor assembly is penetrated by an alternating magnetic field and helps to reduce heat transfer from the susceptor assembly 612 to the susceptor holder.

FIG. 10B shows a schematic illustration of a ninth example of a susceptor assembly for the aerosol-generating system of FIG. 6A. The susceptor assembly 712 comprises a pair of mounting regions 722 and a heating region 724. The susceptor assembly 712 is substantially rectangular. The heating region 724 is a substantially rectangular region located centrally on the susceptor assembly. The pair of mounting regions 722 are also substantially rectangular regions located at the periphery of the heating region 724, at opposite sides of the heating region 724. In this embodiment, the mounting regions 722 are arranged at the same central position along the length of the heating region 724.

Each of the pair of mounting regions 722 has a smaller surface area than the heating region 724. The width w_{mb} of each of the mounting regions 722 is less than the width w_{hb} of the heating region 724. In this embodiment, the heating region 724 and the mounting regions have a length l_{mhb} of about 6.50 millimetres. The heating region has a width whb of about 3.50 millimetres. The mounting regions have a width of about 1.15 millimetres. As such, the susceptor assembly 712 has a total length of about 6.50 millimetres, and a total width of about 5.80 millimetres.

The heating region 724 is configured to be heatable by penetration with an alternating magnetic field, for vapourising an aerosol-forming substrate. The pair of mounting regions 22 are configured to contact a susceptor holder, such that the susceptor holder can support the susceptor assembly 12 in position in an aerosol-generating system, for example in a cartridge. The pair of mounting regions 22 are configured to minimise heat transfer from the susceptor assembly to the susceptor holder.

The heating region 724 comprises a woven mesh of first filaments and second filaments, as described for FIG. 8A. Briefly, the heating region comprises filaments of a first, electrically conductive material extending in a first direction and filaments of a second, wicking material, extending in a second direction perpendicular to the first direction. The first direction is substantially parallel to an alternating magnetic field generated by an inductor coil that surrounds the susceptor assembly (not shown in FIG. 10B). The filaments of the first, magnetic, material are inductively heated by the alternating magnetic field. The second material is a wicking, non-electrically conductive material.

The outer mounting regions 722 comprise a woven mesh of filaments of the second material. The woven mesh comprises filaments of the wicking material and interstices defined between the filaments, the mesh transports by capillary action liquid aerosol-forming substrate from a liquid reservoir to the susceptor assembly, and across the susceptor assembly 712. There are no filaments of the first material or any electrically conductive material in the mounting region of FIG. 10b. Therefore, no heat is generated in the mounting regions 722 of the susceptor assembly 712.

Providing the susceptor assembly 712 with mounting regions 722 having a reduced cross-section compared to the heating region 724, and having no electrically conductive material in the mounting regions 722 helps to reduce heating of the mounting regions 722 when the susceptor assembly is penetrated by an alternating magnetic field. Such a configuration also helps to reduce heat transfer from the susceptor assembly 712 to the susceptor holder.

FIG. 11 shows a schematic illustration of a cross-section of a third example of an aerosol-generating system according to the present disclosure. The aerosol-generating system 800 comprises the majority of the components of the aerosol-generating system 500 shown in FIGS. 6A and 6B, and operates in a similar manner. One difference is that the aerosol-generating system 800 does not comprise a separate cartridge, and most of the features of the cartridge 510 according to FIGS. 6A-7B are instead incorporated into the aerosol-generating system 800.

As described previously, the aerosol-generating system 800 comprises a generally cylindrical system outer housing 862 having a mouth end and a distal end opposite the mouth end. An air inlet 865 is provided through the system outer housing 862 into the system 800.

The system 800 further comprises an inductive heating arrangement arranged within the system outer housing 862. The inductive heating arrangement includes an inductor coil 890, control circuitry 870 and a power supply 872. The control circuitry 870 is connected to the power supply 872, and to the inductor coil 890, such that the control circuitry 870 controls the supply of power to the inductor coil 890. The control circuitry 870 is configured to supply an alternating current to the inductor coil 890.

The singular inductor coil 890 is positioned around the susceptor assembly 812. The inductor coil 890 has a size and a shape matching the size and shape of the heating regions of the susceptor assembly 812. The inductor coil 890 is configured such that when the alternating current is supplied to the inductor coil, the inductor coil generates an alternating magnetic field in the region of the susceptor assembly 812.

The inductive heating arrangement further includes a flux concentrator element 891, as described previously.

The susceptor assembly 812 and susceptor holder 814 are identical to the susceptor assembly 512 and susceptor holder 514 presented in FIGS. 6A to 8B. The susceptor assemblies as described in FIGS. 9-10B are other examples of susceptor assemblies suitable for the aerosol-generating system according to this embodiment.

As described previously, the susceptor holder 814 also comprises a base 830 that partially closes one end of the internal passage 826. The base 830 comprises a plurality of air inlets that enable air to be drawn into the internal passage 826 through the partially closed end. The skilled person would understand however that as the system 800 does not comprise a removable cartridge, that the susceptor holder may instead be integrally formed with the system 800, in particular with the system outer housing 862.

Similarly, the aerosol-generating system 800 further comprises a liquid reservoir 844. The liquid reservoir 844 is defined by the system outer housing 862 for holding a liquid aerosol-forming substrate 842. The liquid reservoir comprises an annular space defined by the system outer housing 862. The annular space has an internal passage 848 that extends between the mouth end opening 838, and the open end of the internal passage 826 of the susceptor holder 814. The liquid reservoir 844 further comprises two channels 845, the two channels 845 being defined between an outer surface of the susceptor holder 814, and an internal surface of the system. The two channels 845 extend from the annular space defined by the system outer housing 862 at the mouth end of the system 800, to the connection end of the system 800, such that a portion of the susceptor assembly 812 extends through the openings in the side wall of the susceptor holder 814 into the two channels 845. The two channels 845 extend from the annular space defined by the system outer housing 862 at the mouth end of the system 800 on opposite sides of the internal passage 826 of the susceptor holder 814.

Similarly, an air passage is formed through the system 800 by the internal passage 826 of the susceptor holder 814, and the internal passage 848 of the liquid reservoir 844. The air passage extends from the air inlets in the base 830 of the susceptor holder 814, through the internal passage 826 of the susceptor holder 814, and through the internal passage 848 of the liquid reservoir 844 to the mouth end opening 838. The air passage enables air to be drawn through the system 800 from the air inlet 865 to the mouth end opening 838.

Similarly, the control circuitry 872 includes an airflow sensor 863. The airflow sensor 863 is in fluid communication with the passage of ambient air which is drawn through the system 800 by the user. The control circuitry 872 supplies electrical power to the heating susceptor assembly 812 when user puffs on the system 800 are detected by the airflow sensor 863.

When the system is activated, an alternating current is established in the inductor coil 890 which causes the susceptor assembly 812 to inductively heat. Liquid aerosol-forming substrate 842 in the channels 845 is drawn into the susceptor assembly 812. The liquid aerosol-forming substrate 842 at the first filaments of the electrically conductive material is heated, and volatile compounds from the heated aerosol-forming substrate are released into the air passage 826, 848 of the system 800, which cool to form an aerosol. The aerosol is entrained in the air being drawn through the air passage 826, 848 of the system 800, and is drawn out of the system 800 at the mouth end opening 838 for inhalation by the user.

Any of the sixth to the ninth exemplary susceptor assemblies may be implemented in the aerosol-generating system of FIG. 11.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A susceptor assembly for an aerosol-generating system, the susceptor assembly comprising:
an array of filaments of a wicking material configured to convey liquid aerosol-forming substrate, the array of filaments forming a mesh; and
at least one filament of an electrically conductive material heatable by penetration with an alternating magnetic field, wherein the at least one filament of the electrically conductive material is wrapped around and in contact with a first filament of the array of filaments of the wicking material.

17. The susceptor assembly according to claim 16, wherein the mesh comprises a plurality of longitudinal filaments of the wicking material that extend in a substantially longitudinal direction and a plurality of lateral filaments of the wicking material that extend in a substantially lateral direction.

18. The susceptor assembly according to claim 17, wherein the at least one filament of the electrically conductive material is wrapped around a longitudinal filament.

19. The susceptor assembly according to claim 16, wherein a first filament of the at least one filaments of the electrically conductive material is wrapped around only a first filament of the wicking material.

20. The susceptor assembly according to claim 19, wherein a second filament of the at least one filaments of the electrically conductive material is wrapped around and in contact with the first filament of the wicking material.

21. The susceptor assembly according to claim 16, wherein at least one filament of the electrically conductive material comprises a helical coil.

22. The susceptor assembly according to claim 16, wherein the mesh is a fluid-permeable woven mesh.

23. A cartridge for an aerosol-generating system, the cartridge comprising:
the susceptor assembly according to claim 16; and
a liquid reservoir configured to hold a liquid aerosol-forming substrate in fluid communication with the susceptor assembly.

24. The cartridge according to claim 23, wherein at least one of the plurality of lateral filaments of the wicking material is in physical contact with the liquid reservoir.

25. An aerosol-generating system, comprising:
the susceptor assembly according to claim 16;
a liquid reservoir configured to hold a liquid aerosol-forming substrate in fluid communication with the susceptor assembly;
an inductor coil arranged around the susceptor assembly and configured to generate an alternating magnetic field that penetrates the susceptor assembly for heating the electrically conductive material; and
control circuitry connected to the inductor coil and configured to provide a current to the inductor coil.

26. The aerosol-generating system according to claim 25,
wherein the mesh comprises a plurality of longitudinal filaments of the wicking material that extend in a substantially longitudinal direction and a plurality of lateral filaments of the wicking material that extend in a substantially lateral direction, and
wherein the inductor coil is arranged to generate a magnetic field that penetrates the susceptor assembly in a direction substantially parallel to the plurality of longitudinal filaments of the wicking material.

27. An aerosol-generating system, comprising:
a liquid reservoir configured to hold a liquid aerosol-forming substrate;
a susceptor assembly comprising a mesh, the mesh comprising a plurality of filaments of a first material extending in a first direction and a plurality of filaments of a second material extending in a second direction, wherein the first material is an electrically conductive material heatable by penetration with an alternating magnetic field and the second material is a wicking material configured to convey liquid from the liquid reservoir to the susceptor assembly;
an inductor coil arranged around the susceptor assembly to generate an alternating a magnetic field configured to penetrate the susceptor assembly in a direction substantially parallel to the first direction; and
control circuitry connected to the inductor coil and configured to provide current to the inductor coil.

28. The aerosol-generating system according to claim 27, wherein the first direction is substantially perpendicular to second direction.

29. The aerosol-generating system according to claim 27, wherein the inductor coil is arranged to circumscribe the susceptor assembly.

30. The aerosol-generating system according to claim 27, wherein the mesh is woven.
